(19) United States
(12) Patent Application Publication
(10) Pub. No.: US 2020/0098003 A1
(43) Pub. Date: Mar. 26, 2020

(54) INFORMATION SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Shinji ICHIKAWA, Nagoya-shi (JP); Harunobu SAITO, Nagoya-shi (JP); Daiki KANEICHI, Nisshin-shi (JP); Ryotaro FUJIWARA, Tokyo-to (JP); Megumi AMANO, Toyota-shi (JP); Masato ENDO, Nagakute-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/582,424

(22) Filed: Sep. 25, 2019

(30) Foreign Application Priority Data
Sep. 25, 2018 (JP) 2018-178373

(51) Int. Cl. G06Q 30/02

(52) U.S. Cl. CPC G06Q 30/0257; G06Q 30/0266; G06Q 30/0256; G06Q 30/0261

(57) ABSTRACT

A display technique for displaying an advertisement content which takes account of a relation with respect to any personal experience and/or any action of a target person is provided. An information system comprises a controller including at least one processor. The controller is configured to execute: acquisition of specification information for specifying display information to be displayed on a signage apparatus, of a user as inputted by the aid of an input unit; and output of the display information to the signage apparatus at a predetermined timing.

### CROSS-REFERENCE TO RELATED APPLICATIONS

This application claims the benefit of Japanese Patent Application No. 2018-178373, filed on Sep. 25, 2018, which is hereby incorporated by reference herein in its entirety.

### BACKGROUND

### Technical Field

The present disclosure relates to an information system for displaying a digital signage, an information processing method, and a non-transitory storage medium.

### Description of the Related Art

In recent years, an advertisement form such as the so-called digital signage (electronic signboard), in which an electronic advertisement is displayed on a display device at various places including, for example, an underground shopping area, a road neighborhood, and a commercial facility, becomes widespread. As a technique for enhancing the effect of the advertisement displayed on the digital signage, Patent Literature 1 discloses such a technique that an advertisement occupation state is generated by simultaneously displaying an identical advertisement content on a plurality of signage apparatuses positioned in a predetermined range.

### CITATION LIST

### Patent Literature

Patent Literature 1: Japanese Patent Application Laid-Open No. 2018-013514

### SUMMARY

The background art described above resides in such a technique that a so-called mass-advertisement is displayed, in which the advertisement target is a large number of unspecified consumers. In this case, for example, no consideration is made about the display of any advertisement content which takes account of any relation with respect to any personal experience and/or any action of a consumer. An object of the present disclosure is to provide a display technique for displaying an advertisement content which takes account of a relation with respect to any personal experience and/or any action of a consumer.

One aspect of the present disclosure is exemplified as an information system. This information system comprises a controller including at least one processor. The controller may be configured to execute: acquisition of specification information for specifying display information to be displayed on a signage apparatus, of a user as inputted by the aid of an input unit; and output of the display information to the signage apparatus at a predetermined timing.

Another aspect of the present disclosure is exemplified as an information processing method. That is, the present disclosure may reside in an information processing method causing a computer to execute: a step of acquiring specification information for specifying display information to be displayed on a signage apparatus, of a user as inputted by the aid of an input unit; and a step of outputting the display information to the signage apparatus at a predetermined timing.

Still another aspect of the present disclosure is exemplified as an information processing program to be executed by a computer, or a non-transitory storage medium stored with the information processing program. In such case, the informaiton processing program may be configured to make to cause a computer to execute: a step of acquiring specification information for specifying display information to be displayed on a signage apparatus, of a user as inputted by the aid of an input unit; and a step of outputting the display information to the signage apparatus at a predetermined timing, or a computer-readable storage medium on which the program is stored non-transitorily.

According to the present disclosure, it is possible to provide a display technique for displaying an advertisement content which takes account of a relation with respect to any personal experience and/or any action of a consumer.

### BRIEF DESCRIPTION OF DRAWINGS

FIG. 1 is a diagram illustrating an exemplary system configuration of a signage system according to a first embodiment.

FIG. 2 explains a purchased signage frame.

FIG. 3 is a diagram illustrating an exemplary hardware configuration of each of a management server, a terminal device, and a signage apparatus.

FIG. 4 is a diagram illustrating an exemplary functional configuration of the management server.

FIG. 5 is a diagram illustrating an exemplary reservation display information stored in reservation display information DB.

FIG. 6 is a flow chart illustrating an exemplary registration process for purchase reservation of the signage frame.

FIG. 7 is a flow chart illustrating an exemplary display process for displaying message information and display information reserved to be purchased.

FIG. 8 is a flow chart illustrating the exemplary display process for displaying the message information and the display information reserved to be purchased.

FIG. 9 is a diagram illustrating an exemplary functional configuration of a management server according to a first modification.

FIG. 10 is a flow chart illustrating an exemplary display process according to the first modification.

FIG. 11 is a flow chart illustrating an exemplary display process according to a second modification.

FIG. 12 is a diagram illustrating an exemplary system configuration of a signage system according to a second embodiment.

FIG. 13 is a diagram illustrating an exemplary functional configuration of a management server according to the second embodiment.

FIG. 14 is a diagram illustrating an exemplary advertisement information stored in advertisement information DB according to the second embodiment.

FIG. 15 is a flow chart illustrating an exemplary display process for displaying display information according to the second embodiment.

FIG. 16 is a diagram illustrating an exemplary functional configuration of a management server according to a third embodiment.

FIG. 17 is a diagram illustrating an exemplary reservation display information stored in reservation display information DB according to the third embodiment.

FIG. 18 is a flow chart illustrating an exemplary acquiring process for acquiring visual recognition information.

FIG. 19 is a flow chart illustrating an exemplary display process according to the third embodiment.

### DESCRIPTION OF EMBODIMENTS

A signage system according to a first aspect of the embodiment of the present disclosure comprises a controller which executes acquisition of specification information for specifying display information to be displayed on a signage apparatus, of a user as inputted by the aid of an input unit; and output of the display information to the signage apparatus at a predetermined timing. In this context, the display information can be exemplified by an advertisement content of a merchandise or the like provided by an advertiser.

According to the aspect as described above, the signage system makes it possible to display the advertisement content adapted to the preference and/or the purpose of the user, as the display information on the date and time in the time zone designated by the user, on the signage apparatus designated by the user. Further, the display information can be displayed at a timing at which the user himself/herself or the target person intended by the user can visually recognize the display information displayed on the signage apparatus. Further, the display information can include advertisement information which is free of charge and which is provided at an expense or cost borne by an advertiser. In the aspect as described above, it is possible to display the advertisement content which takes account of the relation with respect to any personal experience and/or any action of the user.

In the first aspect, the controller may execute detection of the user himself/herself or the target person intended by the user; and output of the display information to the signage apparatus by taking an opportunity of the detection of the user himself/herself or the target person intended by the user. According to the aspect as described above, the signage system can display the display information displayed on the signage apparatus at the timing at which the target person is detected. Therefore, it is possible to raise the possibility to visually recognize the display information.

In the first aspect, the controller may further execute acquisition of visual recognition information with respect to the display information displayed on the signage apparatus, from the user himself/herself or the target person intended by the user; accumulation of histories of the visual recognition information with respect to the display information displayed on the signage apparatus; and output of message information set previously together with the display information, if the accumulated visual recognition information with respect to the display information arrives at a certain number of times. In this context, the visual recognition information is the information which indicates that the display information displayed on the signage apparatus has been read or viewed (visually recognized).

According to the aspect as described above, the signage system makes it possible to display the display information corresponding to the viewing situation (reading situation) of the target person in relation to the display information displayed on the signage apparatus. Further, it is possible to more effectively enhance the relation with respect to the target person who reads or views the display information by including the message information directed to the target person.

An embodiment will be explained below with reference to the drawings. The configuration of the following embodiment is shown by way of example. The mode for carrying out the present disclosure is not limited to the configuration of the embodiment explained below.

### First Embodiment

(System Outline)

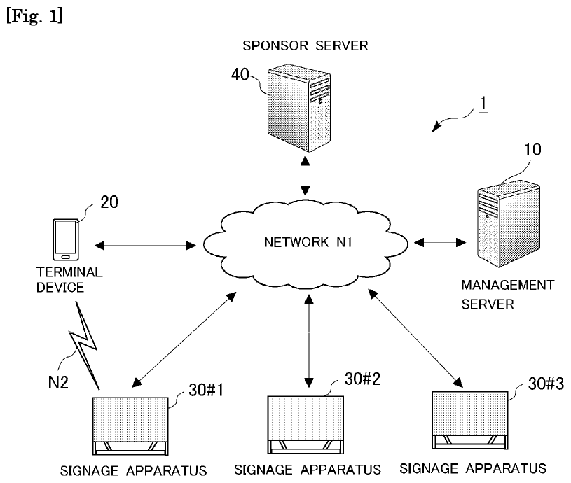

FIG. 1 is a diagram illustrating exemplary system configuration of a signage system 1 according to a first embodiment. The signage system 1 illustrated in FIG. 1 is a system for outputting display information to signage apparatuses at a timing at which a target person intended by a consumer can visually recognize the display information. The signage system 1 is an example of “information system”. In this embodiment, the display information refers to electronic advertisement data including contents composed of, for example, still images and moving images.

The signage system 1 according to the first embodiment comprises a management server 10, a terminal device 20, a plurality of signage apparatuses (30#1 to 30#3), and a sponsor server 40 which are connected to one another by means of a network N1. The network N1 is, for example, a public network such as the internet or the like. The network N1 may include wireless networks of the mobile phone network, exclusive networks such as VPN (Virtual Private Network) and the like, and networks such as LAN (Local Area Network) and the like.

Further, the terminal device 20 is connected to the plurality of signage apparatuses (30#1 to 30#3) respectively by the aid of a network N2. The network N2 is a short distance wireless network including, for example, Bluetooth (registered trade name), NFC (Near Field Communication), UWB (Ultra-Wideband), Wi-Fi (registered trade name), and BLE (Bluetooth Low Energy). The terminal device 20 can be directly communicated with the plurality of signage apparatuses (30#1 to 30#3) respectively by the aid of the network N2.

Note that in FIG. 1, one management server 10, one terminal device 20, one sponsor server 40, and three signage apparatuses (30#1 to 30#3) are representatively illustrated by way of example. A plurality of management servers 10, a plurality of terminal devices 20, and a plurality of sponsor servers 40 may be connected to the network N1. Further, the number of signage apparatuses connected to the network N1 is not limited to the number illustrated by way of example. Any number of signage apparatuses may be used. In the following description, the plurality of signage apparatuses, which may be connected to the network N1, are generally referred to as “signage apparatus 30” as well.

The sponsor server 40 is a server apparatus which is managed, for example, by an advertising agency or an enterprise as an advertiser. The electronic advertisement data, which includes the contents composed of, for example, the still image and/or the moving image as requested to be displayed by the advertiser, is registered as the display information in the management server 10 by the aid of the sponsor server 40. The display information, which is requested to be displayed by the advertiser, is registered in the management server 10, for example, together with the information which indicates, for example, the area in which the signage apparatus 30 is installed, the period and the time zone in which the display information is to be displayed on the signage apparatus 30, and the configuration pattern of the advertisement data which is to be displayed as the display information. As for the display information which is registered in the management server 10 by the aid of the sponsor server 40, the advertiser is a defrayer who bears the charge in relation to the use of the signage apparatus 30 on which the display information is displayed.

The signage apparatus 30 is an apparatus which receives the display information outputted from the management server 10 and which displays the display information on a display device. The display device may be constructed integrally with the signage apparatus 30. Alternatively, the display device may be constructed separately from the signage apparatus. The display device, which is provided for the signage apparatus 30, is constructed by using, for example, a liquid crystal display, an organic EL display, an LED matrix, or a projector.

Note that the display form of the display information displayed by the signage apparatus 30 may be, for example, AR (Augmented Reality) in which visual information generated, for example, by CG (Computer Graphics) or the like is displayed in a superimposed manner on an existent landscape of a place at which the signage apparatus is installed. Similarly, the display form may be, for example, the projection mapping (Projection Mapping) as well in which visual information generated by CG or the like is projected onto a building, an object, and/or a space disposed closely to a place at which the signage apparatus 30 is installed.

The terminal device 20 is, for example, a small-sized computer such as a smartphone, a mobile phone terminal, a tablet terminal, a personal information terminal, a wearable computer (for example, a smartwatch) or the like. However, the terminal device 20 may be a personal computer (PC: Personal Computer) which can be carried by a consumer. Alternatively, the terminal device 20 may be a vehicle onboard apparatus which is carried on a vehicle driven and operated by a target person who reads or views the display information displayed on the signage apparatus 30.

An application program (hereinafter referred to as “application” as well) is installed in the terminal device 20 possessed by the consumer, for example, in order to purchase the signage frame of the signage apparatus 30. In this context, the signage frame refers to the allotment of the display period (date and time, time zone) of the display information in relation to the signage apparatus 30. The signage frame is purchased together with the designation of the display information and the signage apparatus 30 for displaying the display information as well as the period (date and time, time zone) for displaying the display information. The consumer purchases the signage frame by executing the application. Thus, the signage frame, which allows the signage apparatus 30 installed at a desired place to display the display information adapted to the preference and/or the purpose, can be reserved and registered in the management server 10.

The management server 10 according to the first embodiment manages the display information displayed on the signage apparatus 30. The display information is managed while being correlated with the period and the time zone for displaying the display information on the signage apparatus, for example, for every place (point) at which the signage apparatus 30 is provided.

Then, the management server 10 according to the first embodiment accepts the purchase of the signage frame from the consumer (hereinafter referred to as “user” as well) who operates the terminal device 20 in which the application is executed. The management server 10 accepts the purchase of the signage frame, for example, together with the designation of the period (date and time, time zone) of the signage frame desired to be purchased and the information for designating the area in which the signage apparatus 30 is installed.

The management server 10 extracts the signage apparatus 30 capable of being purchased, for example, from the registered display information and the information for designating the period of the signage frame desired to be purchased as accepted from the user and the installation area of the signage apparatus 30. The management server 10 notifies the terminal device 20 of the genre to which the display information registered for the signage apparatus belongs, together with the position information of the extracted signage apparatus 30. In this context, the display information, which is registered in the management server 10 by the aid of the sponsor server 40, is the information which is previously determined to be displayed on the signage apparatus 30. Therefore, the expense or cost, which is to be borne by the user for the use of the signage frame, is free of charge. The defrayer, who bears the charge for the use of the signage frame, is, for example, an advertising agency or an enterprise which has registered the display of the display information.

On the terminal device 20, for example, the installation place of each of the signage apparatuses notified by the aid of the application is displayed on a map. Further, a list of the genres to which the display information (advertisement contents) registered for the signage apparatus belongs is displayed. The user reads or views, for example, the information displayed on the terminal device 20 to specialize the display information which is adapted to the preference and/or the purpose of the user himself/herself and the signage apparatus 30 on which the display information is to be displayed so that the signage frame, which is the purchase target, is determined. Further, the user inputs message information intended to be displayed together with the display information, in accordance with a guidance screen of the application on the terminal device 20. Similarly, the user inputs the information to specify the target person who is allowed to read or view the display information displayed on the signage apparatus 30. The information to specify the target person is, for example, an automobile registration number (for example, a number marked on a number plate or license plate) of a vehicle possessed by the target person, or identification information (for example, telephone number, male address, or MAC address) of the terminal device 20 possessed by the target person. The terminal device 20 accepts, for example, the operation input for the determination of the purchase reservation by the user, and the terminal device 20 notifies the management server 10 of the selected display information, the signage apparatus 30, the inputted message information, and the information to specify the target person.

The management server 10 manages the signage frame notified from the terminal device 20 of the user as the reservation display information. Then, the management server 10 allows the signage apparatus 30 to display the display information and the message information selected to be adapted to the preference and/or the purpose of the user on the date and time and in the time zone as reserved as described later on. The management server 10 detects the target person, for example, on the basis of the information for specifying the target person intended by the user, and the management server 10 allows the signage apparatus 30 to display the display information at the timing at which the target person can visually recognize the display information.

Note that it is assumed for the signage apparatus 30 that the display information, which is to be displayed in the period of the signage frame designated by the user, is undecided. In such a case, for example, it is also allowable to display the display information adapted to the preference and/or the purpose of the user on condition that the user bears the charge of the use of the signage frame.

The management server 10 notifies the user of the signage apparatuses 30 while including the signage apparatus 30 in which the display information is undecided, i.e., the registration of the display information is not performed by the aid of the sponsor server 40, for example, when the signage apparatus 30 is extracted. However, the user is notified of the signage apparatus 30 for which the display information is undecided, while being added with an identifier which indicates that there is a charge. For example, the terminal device 20 distinguishes that the signage apparatus 30 is charged (not free of charge) on the basis of the identifier, and the terminal device 20 displays the signage apparatus 30 together with other signage apparatuses 30 which are free of charge. Then, if the signage apparatus 30, which is charged (not free of charge), is selected, the management server 10 may manage the signage frame reserved to be purchased as the reservation display information, for example, on condition that the payment of the charge for use is confirmed.

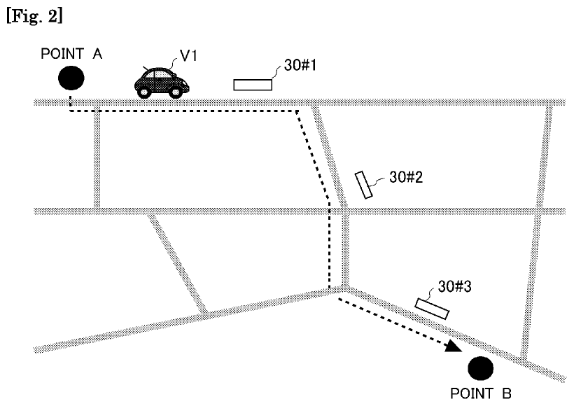

FIG. 2 explains the purchased signage frame. With reference to FIG. 2, it is assumed that the vehicle V1 is a vehicle driven by the target person by whom the display information displayed on the signage apparatus 30 is intended to be viewed. It is assumed that the vehicle V1 travels from Point A which is the place of employment of the target person to Point B which is the home via the route indicated by the broken line arrow. The signage apparatuses 30#1, 30#2, 30#3 are successively provided along the road starting from Point A toward Point B on the route of the vehicle V1.

In this case, for example, it is assumed that the target person is a father of a child who wants to get his/her father to buy a popular game. The child asks his/her mother to purchase, for example, the signage frames of the signage apparatuses 30#1, 30#2, 30#3 capable of displaying advertisement contents of the game. Mother reserves and purchases the signage frames of the signage apparatuses 30#1, 30#2, 30#3 by using the application carried on the terminal device 20. For example, a signage frame of the display information including the advertisement contents of the game and an enterprise name “SQE**x”, which is dealt with by an advertising agency, is reserved while designating a due date and a time zone.

The vehicle V1 driven by the target person (father) passes in front of the signage apparatus 30#1 provided along the road in the time zone designated in the signage frame on the designated due date. For example, the management server 10 outputs an advertisement content of the game selected by mother as the display information to the signage apparatus 30#1 in the designated time zone on the designated due date of the reserved signage frame. The display information displayed in the time zone, for example, a still image drawn with a character of a hero of the game is displayed together with the enterprise name, with respect to the target person who passes in front of the signage apparatus 30#1.

The vehicle V1, which is traveling from Point A to Point B, passes in front of the signage apparatus 30#2 in a time zone designated in the signage frame. The management server 10 outputs the display information including an advertisement content of the game in the time zone on the due date designated in the signage frame of the signage apparatus 30#2 in the same manner as the signage apparatus 30#1. For example, a predetermined battle scene of the game is displayed as a moving image, and a still image of the enterprise name including a game title is displayed for the target person who passes in front of the signage apparatus 30#2.

Then, the vehicle V1 driven by the target person passes in front of the signage apparatus 30#3 provided in the vicinity of the home in a time zone designated in the signage frame. The display information including an advertisement content of the game is outputted to the signage apparatus in the same manner as the other signage apparatuses 30. For example, a scene, in which the predetermined character of the game successfully makes a wining pose, is displayed as a moving image, and a still image of the enterprise name including the game title is displayed for the target person who passes in front of the signage apparatus 30#3. Note that if any message information is inputted when the signage frame is purchased, the message information is displayed while being superimposed on the moving image.

As described above, in the signage system 1 according to this embodiment, the person (father who drives the vehicle V1), who is intended to see the display information (advertisement content of the game) intended to be seen, can be allowed to read or view the display information at the timing (in the time zone in which the display information can be visually recognized) at which the display information is intended to be seen. The signage system 1 makes it possible to provide the opportunity to connect the user who reserved and purchased the signage frame and the target person who is intended by the user, by using the display information and the signage frame of the signage apparatus 30. Further, the target person who reads or views the display information can be more effectively connected to the user who designates the display information, by including the message information directed to the target person.

The following case is exemplified as another opportunity. For example, with reference to FIG. 2, it is assumed that a user, who reserved and purchased the signage frame, drives the vehicle V1. It is assumed that a fellow passenger, to whom the user intends to propose, gets on the vehicle V1. It is assumed that the vehicle V1 travels, for example, from Point A which is the place of employment of the fellow passenger to Point B which is the home of the fellow passenger via the route indicated by the broken line arrow. The signage apparatuses 30#1, 30#2, 30#3 are successively provided along the road starting from Point A toward Point B on the route of the vehicle V1.

The user has executed the application carried on the terminal device 20 possessed by himself before the due date on which the user will propose. The user has purchased the signage frame while designating the time zone and the due date on which the user will propose, together with the area including Point A and Point B. For example, the signage apparatuses 30#1, 30#2, 30#3 have been reserved for a signage frame dealt with by an advertising agency to display the display information of a famous enterprise “TF**Ny” of ornaments and noble metals. The selected display information includes a plurality of configuration patterns. Advertisement contents of different configuration patterns are displayed on the signage apparatuses respectively. For example, the signage apparatus 30#1 displays a still image of an engagement ring, and the signage apparatus 30#2 displays a moving image of an actress who smiles while looking at the worn engagement ring. Further, the signage apparatus 30#3 displays a moving image of a movie scene in which an actor, who holds the engagement ring in his hand, proposes.

Note that as for the signage apparatus 30#3, the message information, which is to be displayed together with the display information, is registered, and the terminal device 20, which is possessed by the user, is registered as the information for specifying the target person. The terminal device 20 periodically transmits the position information (latitude, longitude) of the subject device to the management server 10 at predetermined periodic intervals by the aid of an application as described later on.

The management server 10 detects the user who approaches the installation places of the respective signage apparatuses in the designated time zone, for example, on the basis of the position information transmitted from the terminal device 20, and the management server 10 allows the signage apparatuses to display the reserved display information. The management server 10 allows the signage apparatus to display the reserved display information, for example, on condition that the terminal device 20 is positioned within a predetermined threshold value range with respect to the installation place of each of the signage apparatuses.

The fellow passenger of the vehicle V1 driven by the user can firstly visually recognize the still image of the engagement ring which is displayed at the timing at which the vehicle V1 passes in front of the signage apparatus 30#1 installed at the place near to the place of employment. Subsequently, the fellow passenger, who is traveling toward the home, can visually recognize the moving image of the actress who smiles whole looking at the worn engagement ring as displayed at the timing at which the vehicle V1 passes in front of the signage apparatus 30#2. Then, the fellow passenger can visually recognize the moving image of the movie scene in which the actor, who holds the engagement ring in his hand, proposes and the message information of the user having been previously registered, as displayed at the timing at which the vehicle V1 passes in front of the signage apparatus 30#3 installed in the vicinity of the home. For example, the user can stop the vehicle V1 in front of the signage apparatus 30#3 on which the moving image is displayed, and the user can propose to the fellow passenger so that an actual engagement ring may be handed to the fellow passenger. Even in such a case, the signage system 1 according to the first embodiment makes it possible to display the advertisement content which takes account of the relation with respect to the personal experience and/or the action of the consumer.

Note that the user who approaches the signage apparatus 30 or the target person who is intended by the user may be detected by means of any form other than the position information described above. For example, the detection can be also performed on the basis of a screen image photographed by a camera. For example, it is assumed that the signage apparatus 30 is provided with a camera for photographing the vehicle or the like which passes in front of the subject apparatus. Further, it is assumed that the automobile registration number of the vehicle driven by the user or the target person is registered as the information for specifying the target person in the management server 10.

The management server 10 instructs the signage apparatus 30 to photograph those existing in front of the signage apparatus, for example, at a time to start the reserved time zone. Then, the management server 10 acquires the photographed image to specify the vehicle driven by the user or the target person on the basis of the collation between the photographed image photographed by the signage apparatus 30 and the previously registered automobile registration number. The management server 10 may instruct the signage apparatus 30 to display the display information including the advertisement content, for example, at the timing at which the previously registered automobile registration number is detected in the photographed image having been photographed.

Further, the user who approaches the signage apparatus 30 or the target person who is intended by the user can be also detected by the aid of a short distance wireless network with respect to the terminal device 20. It is assumed that the signage apparatus 30 is provided with, for example, a communication unit capable of performing the short distance wireless communication, and the identification information (for example, MAC address or the like) of the terminal device 20 possessed by the user or the target person is registered in the management server 10.

The management server 10 instructs the signage apparatus 30 to transmit a response request in which the identification information of the terminal device 20 is designated, for example, at the time to start the reserved time zone. The terminal device 20, which exists in the range capable of performing the short distance wireless communication with respect to the installation position of the signage apparatus 30, transmits a response including the identification information of the subject apparatus to the signage apparatus 30 in response to the response request. The management server 10 may instruct the signage apparatus 30 to display the display information including the advertisement content, taking the opportunity of the detection of the transmission of the response with respect to the response request for the terminal device 20 as performed by the signage apparatus 30. Preferably, the detection of the user or the target person intended by the user, which is performed in the signage system 1, may specify at least the timing at which the display information displayed on the signage apparatus can be visually recognized, for example, at which the user or the target person intended by the user approaches the signage apparatus 30.

According to the first embodiment, the management server 10 can display the display information adapted to the preference and/or the purpose of the user on the date and time in the time zone designated by the user, on the signage apparatus 30 designated by the user. Further, the management server 10 can display the message intended by the user together with the display information. Further, the management server 10 can detect the target person on the basis of the information to specify the target person intended by the user, and the management server 10 can display the display information at the timing at which the target person can visually recognize the display information. According to the first embodiment, the contents (display information and message information) can be designated to allow the person who is intended to see the contents (target person intended by the user) to see the contents at the timing (date and time, time zone) at which the contents are intended to be seen, by means of the signage apparatus 30.

(Hardware Configuration)

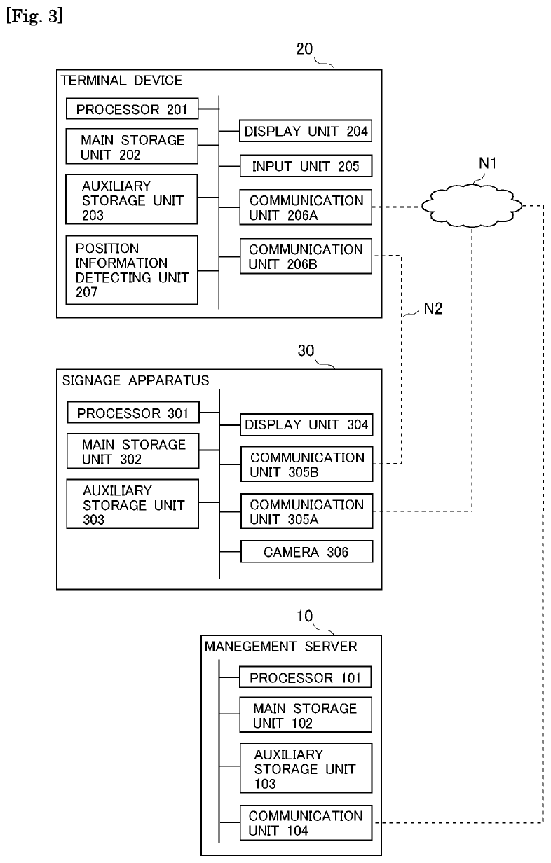

FIG. 3 is a diagram illustrating an exemplary hardware configuration of each of the management server 10, the terminal device 20, and the signage apparatus 30. The sponsor server 40 has hardware configuration which is the same as or equivalent to that of the management server 10, and hence the sponsor server 40 is omitted from FIG. 3. Note that the configuration form of the signage apparatus 30 exemplified in FIG. 3 by way of example is an example of such a form that a communication unit 305B and a camera 306 are provided as constitutive elements or components for detecting the user or the target person existing in a predetermined range. As explained with reference to FIG. 2, if the signage system 1 is constructed such that the user or the target person, who is positioned in a predetermined range from the signage apparatus 30, is detected on the basis of the position information of the terminal device 20, the communication unit 305B and the camera 306 may be omitted. Further, if the signage system 1 is constructed such that the user or the target person, who is positioned in a predetermined range from the signage apparatus 30, is detected by means of the communication between a communication unit 305B and the terminal device 20, the camera 306 may be omitted. Similarly, if the signage system 1 is constructed such that the user or the target person, who is positioned in a predetermined range from the signage apparatus 30, is detected on the basis of a photographed image obtained by the camera 306, the communication unit 305B may be omitted.

The management server 10 is, for example, a general purpose computer or an exclusive computer. The management server 10 is provided with a processor 101, a main storage unit 102, an auxiliary storage unit 103, and a communication unit 104 as constitutive components which are connected to one another by means of a bus. The main storage unit 102 and the auxiliary storage unit 103 are storage media capable of being read by the management server 10. As for the constitutive components described above, a plurality of components may be provided respectively. Alternatively, it is also allowable that one constitutive component or some constitutive components is/are not provided. The processor 101 of the management server 10 is an example of “controller”.

The processor 101 is, for example, CPU (Central Processing Unit). The processor 101 executes the computer program developed executably in an operation area of the main storage unit 102 to control the entire management server 10. The processor 101 provides the function which conforms to the predetermined purpose by controlling peripheral devices by executing the computer program. However, the processor 101 is not necessarily limited to a single process. The processor 101 may be configured as a multiprocessor. Further, single CPU connected by a single socket may have multicore configuration. Further, some of the processing functions provided by the management server 10 may be provided, for example, by DSP (Digital Signal Processor), ASIC (Application Specific Integrated Circuit), or GPU (Graphics Processing Unit). Further, at least some of the processing functions may be exclusive LSI (large scale integration) including, for example, FPGA (Field-Programmable Gate Array), numeric data processor, and image processing processor, or other digital circuits or analog circuits.

The main storage unit 102 stores, for example, the computer program executed by the processor 101 and the data processed by the processor 101. The main storage unit 102 is, for example, a flash memory, RAM (Random Access Memory), and/or ROM (Read Only memory). The auxiliary storage unit 103 is a nonvolatile storage device for readably/writably storing various programs and various data in the storage medium. The auxiliary storage unit 103 is also referred to as “external storage device”. The auxiliary storage unit 103 is, for example, a flash memory, a hard disk drive (HDD, Hard Disk Drive), and/or SSD (Solid State Drive). For example, OS (Operating System) is included in various programs stored in the auxiliary storage unit 103. OS includes a communication interface program for accepting/delivering the data with respect to the external device or the like connected via the communication unit 104.

The communication unit 104 is an interface with respect to the network N1. The communication unit 104 includes, for example, a LAN (Local Area Network) interface board, and a wireless communication circuit for the wireless communication. The management server 10 is connected with the network N1 by the aid of the communication unit 104 to make communication, for example, with the terminal device 20 and the signage apparatus 30 via the network.

Note that the hardware configuration of the management server 10 is not limited to the configuration illustrated in FIG. 3. The management server 10 can read, for example, the program recorded on a transportable storage medium, and the management server 10 can develop the program in the main storage unit 102 so that the program may be executed. The transportable storage medium is, for example, a disk storage medium including, for example, USB (Universal Serial Bus) memory, CD (Compact Disc), DVD (Digital Versatile Disc), and Blu-ray (registered trademark).

The terminal device 20 has a processor 201, a main storage unit 202, an auxiliary storage unit 203, a display unit 204, an input unit 205, a communication unit 206A, a communication unit 206B, and a position information detecting unit 207. The processor 201, the main storage unit 202, and the auxiliary storage unit 203 are the same as or equivalent to the processor 101, the main storage unit 102, and the auxiliary storage unit 103 of the management server 10, and hence any explanation thereof will be omitted. Note that the application, which is usable to reserve and purchase the signage frame, is stored in the auxiliary storage unit 203 of the terminal device 20.

The display unit 204 is, for example, LCD (Liquid Crystal Display) or EL (Electroluminescence) panel. Note that the display unit 204 may be provided with a speaker for informing the user of, for example, a voice guidance and/or a message. The input unit 204 includes, for example, a touch panel or a push-button with which symbols such as letters or the like can be inputted, a microphone with which the voice can be inputted, and a camera with which a moving image and a still image can be photographed.

The communication unit 206A is, for example, a communication circuit which is adapted to the communication system adopted, for example, in the wireless communication such as Wi-Fi or the like, and/or the mobile phone network such as LTE, LTE-Advanced, 3G or the like. The terminal device 20 makes access to the network N1 by the aid of the communication unit 206A to make communication, for example, with the management server 10. The communication unit 206B is a communication circuit which is adapted to the short distance wireless communication including, for example, Bluetooth, NFC, and BLE. The terminal device 20 makes access to the network N2 by the aid of the communication unit 206B to make communication, for example, with the signage apparatus 30 provided, for example, along the road.

The position information detecting unit 207 detects the position information (latitude, longitude) of the subject device, for example, on the basis of the GPS signal sent from a plurality of GPS (Global Positioning Satellite) satellites orbiting around the earth. The position information detecting unit 207 acquires the detected position information at predetermined periodic intervals, and the position information detecting unit 207 records the position information while being correlated with the acquired time information. The information, which is recorded by the position information detecting unit 207, is transmitted to the management server 10 connected to the network N1 by the aid of the communication unit 206A periodically or in response to the request of the management server 10.

Note that the terminal device 20 may be, for example, a navigation apparatus or the like which is carried on the vehicle driven by the user or the target person. In this case, for example, a display unit and an input unit, which are provided for the navigation apparatus or the like, may be shared and allotted to usable constitutive components. Further, a GPS receiving unit, which is provided for the navigation apparatus or the like, may be allotted to the position information detecting unit 207.

The signage apparatus 30 includes a processor 301, a main storage unit 302, an auxiliary storage unit 303, a display unit 304, a communication unit 305A, a communication unit 305B, and a camera 306. The processor 301, the main storage unit 302, and the auxiliary storage unit 303 may be explained in the same manner as in the explanation of the processor 101, the main storage unit 102, and the auxiliary storage unit 103 of the management server 10, and hence any explanation thereof will be omitted. Further, the display unit 304, the communication unit 305A, and the communication unit 305B may be explained in the same manner as in the explanation of the display unit 204, the communication unit 206A, and the communication unit 206B of the terminal device 20, and hence any explanation thereof will be omitted. However, as explained with reference to FIG. 1, constitutive components of, for example, a LED matrix and a projector are included in the display unit 304. Further, the display unit 304 may be provided integrally with a casing of the signage apparatus 30. Alternatively, the display unit 304 may be provided separately from the casing of the signage apparatus 30.

The camera 306 is a photographing device based on an image sensor including, for example, CCD (Charged-Coupled Devices) and CMOS (Complementary Metal-Oxide-Semiconductor). The camera 306 may be either a monocular camera or a stereo camera. Further, the camera 306 may be an infrared camera. Typically, the camera 306 is provided integrally with the casing the signage apparatus 30, and the camera 306 photographs the screen image of those existing approximately in front of the signage apparatus at a predetermined frame period (for example, 30 fps). However, the camera 306 may be provided separately from the casing of the signage apparatus 30. The screen image, which is photographed by the camera 306, is recorded, for example, in the auxiliary storage unit 303 or the like, and the screen image is transmitted to the management server 10 connected to the network N1 by the aid of the communication unit 305A periodically or in response to the request of the management server 10. In the management server 10, for example, the automobile registration number (number marked on the number plate) or the like is detected for the vehicle registered as the information for specifying the target person, for example, by means of the pattern matching with respect to the frame image photographed at the predetermined frame period.

(Functional Configuration)

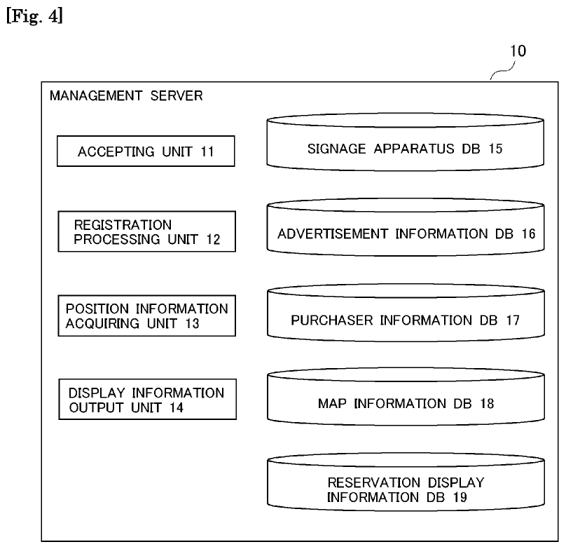

FIG. 4 is a diagram illustrating an exemplary functional configuration of the management server 10. The management server 10 includes, as functional constitutive components, an accepting unit 11, a registration processing unit 12, a position information acquiring unit 13, a display information output unit 14, a signage apparatus database (DB) 15, an advertisement information DB 16, a purchaser information DB 17, a map information DB 18, and a reservation display information DB 19. The map information DB 18 stores the map information including the map data which includes planimetric feature positions and POI (Point of Interest) information which includes letters, photographs and the like for indicating characteristics of respective points on the map data. Note that the map information DB 18 is provided from any other system connected to the network N1, for example, GIS (Geographic Information System). The functional configuration elements or components as described above are, for example, functional configuration elements or components which are provided by executing various programs stored in the auxiliary storage unit 103 by the processor 101 of the management server 10. However, any one of the respective functional configuration elements or components or some of the processes thereof may be executed by any hardware circuit. Alternatively, any one of the respective functional configuration elements or components or some of the processes thereof may be executed by any other computer connected to the network N1.

The accepting unit 11 accepts the electronic advertisement data including contents composed of, for example, still images and moving images requested by the advertiser as the display information to be displayed on the signage apparatus 30, by the aid of the sponsor server 40. The accepting unit 11 stores, in the advertisement information DB 16, the display information accepted by the aid of the sponsor server 40. The advertisement information DB 16 is provided with, for example, records each of which corresponds to every identification information (advertiser ID) for distinguishing the advertiser. The record stores the area ID for indicating the area in which the signage apparatus 30 is installed, the identification information (apparatus ID) of the signage apparatus 30, the identification number for distinguishing the display information, the data of the advertisement content (advertisement data) for constructing the display information, and the display period and the time zone designated by the advertiser. Further, the record stores the information for indicating the genre such as the game, the ornament or the like to which the display information belongs, the data classification information for indicating the display form of the display information (for example, still image, slide show, moving image, projection mapping, AR and the like), and the identification number for indicating the configuration pattern of the advertisement data.

Note that the signage apparatus 30 is managed by the signage apparatus DB 15. The signage apparatus DB 15 is provided with, for example, records each of which corresponds to every apparatus ID of the signage apparatus 30. The record stores the administrator ID which indicates the administrator of the signage apparatus 30, the information which indicates the term of contract in relation to the use of the signage apparatus 30, the area ID, and the position information (latitude, longitude) of the installation place. Further, the record stores the information for indicating the form of the advertisement data capable of being displayed (for example, still image, slide show, moving image, projection mapping, AR and the like) and the limitations or restrictions in relation to the display (for example, period in which display is disapproved). Further, the record stores the presence or absence of the configuration for detecting the target person and the information for indicating the classification of the configuration (for example, camera, short distance wireless communication and the like).

Further, the accepting unit 11 stores, in the purchaser information DB 17, the registration information of the user registered when the application for purchasing the signage frame was downloaded. The purchaser information DB 17 is provided with, for example, records each of which corresponds to every identification information (user ID) for distinguishing the user. The record stores the name and the distinction of sex of the user, the identification information (for example, telephone number, mail address, MAC address and the like) for distinguishing the terminal device 20 of the user, the presence or absence of the acquisition of the position information, and the presence or absence of the short distance wireless communication or the like.

The registration processing unit 12 accepts the purchase of the signage frame from the terminal device 20 by the aid of the application. As for the purchase of the signage frame, those designated are the period (date and time, time zone) of the signage frame desired to be purchased, and the area in which the signage apparatus 30 is installed. For example, the registration processing unit 12 makes reference to the advertisement information DB 16 to extract the signage apparatus 30 which fulfills the purchase condition of the signage frame designated by the user. Then, the registration processing unit 12 notifies the terminal device 20 of the genre to which the display information registered for the signage apparatus belongs, together with, for example, the position information of the extracted signage apparatus 30. Note that the registration processing unit 12 may perform the extraction while including the signage apparatus 30 having any signage frame in which the display information to be displayed in the designated period is undecided (registration of the display information is not performed), and the registration processing unit 12 may notify the terminal device 20. However, as for the signage apparatus 30 corresponding to the signage frame in which the display information is undecided, for example, the terminal device 20 is notified, while an identifier, which indicates that the display information is to be displayed with any charge to be borne by the user, is added. On the terminal device 20, for example, such a signage apparatus 30 is displayed together with the other free signage apparatuses 30, while distinguishing that the signage frame of the signage apparatus 30 is not free of charge, on the basis of the identifier.

The registration processing unit 12 accepts the purchase reservation of the signage frame adapted to the preference and/or the purpose of the user as specialized from the signage frames of which the terminal device 20 is informed. In the purchase registration, the display information and the signage apparatus 30 for displaying the display information are designated. Note that if the display information includes a plurality of configuration patterns, the information for designating the configuration pattern to be displayed is included. Further, the registration processing unit 12 accepts the message information intended to be displayed together with the display information and the information for specifying the target person who is allowed to read or view the display information, as accepted when the purchase of the signage frame was reserved. Then, the registration processing unit 12 stores, in the reservation display information DB 19, the information in relation to the purchase reservation of the signage frame accepted by the aid of the terminal device 20.

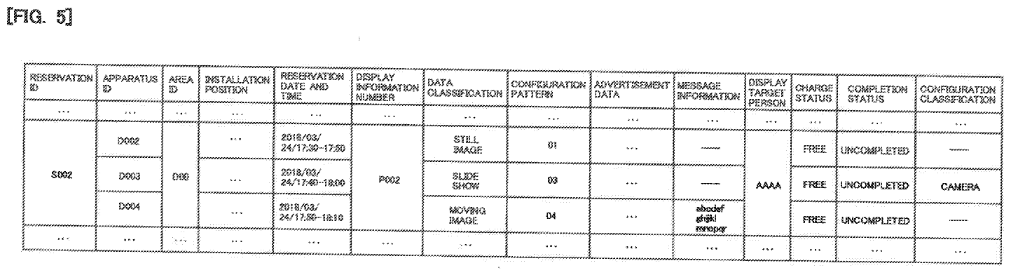

FIG. 5 is a diagram illustrating an exemplary reservation display information stored in the reservation display information DB 19. As illustrated in FIG. 5 by way of example, the information relevant to the purchase reservation of the signage frame accepted from the terminal device 20 operated by the user is managed as a reservation display information table. Note that the field can be appropriately added, changed, and deleted in relation to the information registered in the reservation display information table.

The reservation display information table exemplified in FIG. 5 has respective fields of “reservation ID”, “apparatus ID”, “area ID”, “installation position”, “reservation data and time”, “display information number”, “data classification”, “configuration pattern”, “advertisement data”, “message information”, “display target person”, “charge status”, “completion status”, and “configuration classification”. Reservation ID, which is provided to distinguish the purchase reservation of the signage frame accepted from the user, is stored in the reservation ID field. The identification information of the signage apparatus 30, for which the signage frame was purchased, is stored in the apparatus ID field. Area ID, which is provided to distinguish the area installed with the signage apparatus 30, is stored in the area ID field. The position information (latitude, longitude) of the point at which the signage apparatus 30 is installed is stored in the installation position field.

The date and time information, which is provided to display the reserved display information, is stored in the reservation date and time field together with the time zone. The identification number, which indicates the advertisement data to be displayed as the display information, is stored in the display information number field. The classification of the advertisement content to be displayed as the display information is stored in the data classification field. The classification of the advertisement content includes, for example, the still image, the slide show, the moving image, AR, and the projection mapping. The number, which indicates the configuration pattern of the advertisement content, is stored in the configuration pattern field. The display data of the advertisement content is stored in the advertisement data field.

The message, which is registered by the user and which is to be displayed together with the display information, is stored as the character or letter information in the message information field. Note that the identification number, which is usable to distinguish the character or letter information stored in any other table or the like, may be stored in place of the character or letter information. Further, if the message to be displayed is absent, the information (for example, “---”, blank or the like), which indicates the absence of the message, is stored. The information, which is available to specify the target person allowed to read or view the display information as designated by the user, is stored in the display target person field. The information includes the identification information (for example, telephone number, mail address, MAC address or the like) of the terminal device 20 possessed by the user or the target person intended by the user. Further, the information includes, for example, the automobile registration number (number marked on the number plate) of the vehicle driven by the user or the target person intended by the user. The distinction of the charge to be borne by the user in relation to the use of the signage frame is stored in the charge status field. For example, the status of “not free” is stored if the user bears the charge in relation to the use of the signage frame, while the status of “free” is stored if the advertiser bears the charge. The status information, which indicates that the display for the reserved signage frame is completed, is stored in the completion status field. For example, the status of “uncompleted” is stored if the display is not completed for the reserved signage frame, while the status of “completed” is stored if the display is completed. The classification of the configuration for detecting the target person (for example, camera, short distance wireless communication or the like) is stored in the configuration classification field.

As for the reservation ID “S002” illustrated in FIG. 5, the signage frames of the three signage apparatuses 30 having the apparatus ID's “D002”, “D003”, “D004” installed in the area ID “D00” are reserved for the target of the display target person “AAAA”. The reservation date of the respective signage apparatuses is “2018/03/24”. Further, the charge statuses of the respective signage apparatuses are “free”.

As for the apparatus ID “D002”, the advertisement data of the data classification “still image” distinguished by the configuration pattern “01” of the display information number “P002” is displayed in the reserved time zone “17:30-17:50”. Further, as for the apparatus ID “D003”, the advertisement data of the data classification “slide show” distinguished by the configuration pattern “03” of the display information number “P002” is displayed in the reserved time zone “17:40-18:00”. Similarly, as for the apparatus ID “D004”, the advertisement data of the data classification “moving image” distinguished by the configuration pattern “04” of the display information number “P002” is displayed in the reserved time zone “17:50-18:10”. Note that in the case of the apparatus ID “D004”, the message information “abcdefghijklmnopqr” is displayed together with the display information.

As explained with reference to FIG. 2, the respective signage apparatuses, which are successively installed along the road directed from Point A to Point B and which have the apparatus ID's “D002”, “D003”, “D004” respectively, are allowed to display the designated advertisement contents in the designated time zones. When the display target person “AAAA” passes in front of the apparatus ID “D002” in the reserved time zone “17:30-17:50”, the display target person “AAAA” can visually recognize the advertisement data of “still image” distinguished by the configuration pattern “01” of the display information number “P002”. Similarly, when the display target person “AAAA” passes in front of the apparatus ID “D003” in the reserved time zone “17:40-18:00”, the display target person “AAAA” can visually recognize the advertisement data of “slide show” distinguished by the configuration pattern “03” of the display information number “P002”. Then, when the display target person “AAAA” passes in front of the apparatus ID “D004” in the reserved time zone “17:50-18:10”, the display target person “AAAA” can visually recognize the advertisement data of “moving image” distinguished by the configuration pattern “04” of the display information number “P002” together with the message information.

With reference to FIG. 4 again, the position information acquiring unit 13 acquires the position information transmitted from the terminal device 20, and the position information is temporarily stored in a predetermined area of the main storage unit 102 while allowing the position information to be correlated with the time information and the identification information of the terminal device 20. The terminal device is the terminal device 20 which is designated as the information for specifying the target person allowed to read or view the display information when the signage frame was purchased and reserved. The terminal device 20 is the terminal device 20 which is possessed, for example, by the user or the target person intended by the user. Further, the terminal device 20 may be a vehicle onboard apparatus or device which is carried on the vehicle driven by the user or the target person intended by the user. The position information acquiring unit 13 delivers, for example, the acquired position information to the display information output unit 14.

The display information output unit 14 allows the signage apparatus 30 for which the signage frame is purchased to display the designated display information on the designated due date and in the designated time zone on the basis of the reservation display information table stored in the reservation display information DB 19. The display information output unit 14 allows the signage apparatus 30 to display the display information and the message information at the timing at which the user or the target person intended by the user can visually recognize the display information and the message information on the basis of the position information delivered from the position information acquiring unit. Details of the display information output unit 14 will be described later on.

(Process Flow)

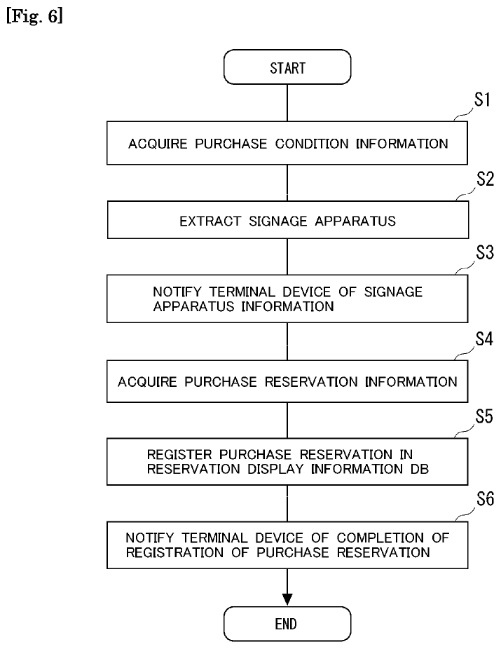

Next, an explanation will be made about the process of the management server 10 according to the first embodiment with reference to FIGS. 6 to 8. FIG. 6 is a flow chart illustrating an exemplary registration process for purchase reservation of the signage frame. In the flow chart illustrated in FIG. 6, the start of the process is exemplified by a timing at which the purchase request for the signage frame is accepted from the terminal device 20 by the aid of the application. The user, who hopes the purchase of the signage frame, transmits, to the management server 10, the purchase condition information including, for example, the information to designate the period (date and time, time zone) of the signage frame and the installation area of the signage apparatus 30. The management server 10 acquires the purchase condition information transmitted from the terminal device 20 (S1). The management server 10 temporarily stores the acquired information in a predetermined area of the main storage unit 102, and the routine proceeds to the process of S2.

The management server 10 extracts the signage apparatus 30 which fulfills the purchase condition of the signage frame designated by the user (S2). The management server 10 makes reference, for example, to the advertisement information DB 16 to specify the signage apparatuses 30 installed in the designated area. The management server 10 extracts the signage apparatus having the signage frame in which the display information is registered in the designated period (date and time, time zone), from the specified signage apparatuses 30. Then, the management server 10 notifies the terminal device 20 of the information (signage apparatus information) relevant to the extracted signage apparatus 30. The management server 10 notifies the terminal device 20 of, for example, the position information of the signage apparatus 30 (installation position, apparatus ID), the display information (display information number, data classification, configuration pattern), and the information of, for example, the genre to which the display information belongs, as the signage apparatus information.

Note that the area designated by the user includes the signage apparatus 30 having the signage frame in which the display information to be displayed in the designated period is undecided (advertiser is absent), as having been already explained. The management server 10 may extract the signage apparatus 30 including the signage apparatus 30 as described above from the advertisement information DB 16, and the management server 10 may notify the terminal device 20. However, the terminal device 20 may be notified of the signage apparatus 30 for which the display information is undecided as described above, for example, while an identifier, which distinguishes that the signage frame is not free of charge, is added. If the signage apparatus 30, for which the signage frame is not free of charge, is reserved, the display information can be displayed at any charge borne by the user.

The terminal device 20 displays the signage apparatus information notified from the management server 10. The terminal device 20 displays the notified installation places of the respective signage apparatuses on the map, for example, by the aid of the application, and the terminal device 20 displays a list of, for example, the genre and the display information to be displayed on the signage apparatus. The user reads or views the information displayed on the terminal device 20 to specialize the display information corresponding to the preference and/or the purpose of the user himself/herself and the signage apparatus 30 on which the display information is to be displayed, and the user determines the signage frame dealt with as the purchase target. Further, the message information intended to be displayed together with the display information and the information to specify the target person who will read or view the display information are inputted in accordance with a guidance screen of the application of the terminal device. The terminal device 20 notifies the management server 10 of the information relevant to the purchase reservation of the signage frame (designation of the signage apparatus 30 and the display information, the message information, and the information to specify the target person) in accordance with the operation performed by the user.

Note that the terminal device 20 may display, as the display information, the advertisement content or a part of the data of the advertisement content to be displayed in the signage frame. For example, the terminal device 20 accepts the selection operation performed by the user such as the tap operation with respect to the signage apparatus 30 displayed on the map. The display information, which is displayed on the signage apparatus, is extracted and displayed. Then, the terminal device 20 accepts the selection operation such as the tap operation performed by the user with respect to, for example, the display information number of the displayed display information, and the terminal device 20 notifies the management server 10 of the request to transmit the advertisement data corresponding to, for example, the display information number. The management server 10 makes reference, for example, to the advertisement information DB 16 to extract the data of the advertisement content corresponding to, for example, the display information number for which the transmission request is accepted. The data is transmitted to the terminal device 20. The terminal device 20 displays the advertisement content including, for example the still image, the slide show, and the moving image to be displayed on the selected signage apparatus 30, on the basis of the transmitted data. The user can read or view the advertisement content displayed on the terminal device 20, and the user can select the display information adapted to the preference and/or the purpose.

The management server 10 acquires the information (purchase reservation information) relevant to the purchase reservation of the signage frame notified from the terminal device 20. The information for designating the signage apparatus 30 and the display information selected in accordance with the preference and/or the purpose of the user, the message information to be displayed together with the display information, and the information for specifying the target person who reads or views the display information displayed on the signage apparatus 30 are acquired. The management server 10 allows the signage apparatus 30 to display the display information at the timing of the date and time in the time zone designated by the user, and thus the target person, who reads or views the display information, can visually recognize the information when (at the timing at which) the user intends to allow the target person to see the information. The management server 10 temporarily stores the acquired information in a predetermined area of the main storage unit 102, and the routine proceeds to the process of S5.

In the process of S5, the management server 10 registers the information relevant to the purchase reservation of the signage frame in the reservation display information DB 19. The management server 10 gives reservation ID to the purchase reservation, and the management server 10 registers the record corresponding to the reservation ID in the reservation display information DB 19. The apparatus ID of the signage apparatus 30 designated by the user is stored in the apparatus ID field. Similarly, the period (date and time, time zone) of the designated signage frame is stored in the reservation date and time field, and the information for distinguishing the display information is stored in the display information number field, the data classification field, and the configuration pattern field respectively. The display data of the advertisement content corresponding to the display information is stored in the advertisement data field.

The message information, which is to be displayed together with the display information, is stored in the message information field, and the information, which is usable to specify the target person who reads or views the display information, is stored in the display target person field. If the designated signage apparatus 30 displays the display information at the charge borne by the user, the information, which indicates that there is any charge, is stored in the charge status field.

The management server 10 notifies the terminal device 20 of the notification of the registration completion after registering the information relevant to the purchase reservation in the reservation display information DB 19 (S6). As for the notification of the registration completion, the terminal device 20 is notified of reservation ID and various information registered in the reservation display information DB 19. After the process of S6, the process illustrated in FIG. 6 comes to the end.

Note that in the process of S6, if the signage apparatus 30, which is not free of charge, is selected, the management server 10 notifies the terminal device 20 of, for example, a predetermined charge to be borne and account information to pay the charge to be borne. Then, the management server 10 may make notification of the registration completion on condition that the predetermined amount of money (charge to be borne) has been paid to the payment account designated by the account information.

According to the process described above, the management server 10 can acquire the information relevant to the signage frame reserved to be purchased in accordance with the preference and/or the purpose of the user by the aid of the terminal device 20. The display information, which is displayed in accordance with the signage frame reserved to be purchased, can include the free advertisement content which is provided by bearing the expense or cost by the advertiser. Further, the management server 10 can acquire the message information which is displayed in accordance with the signage frame reserved to be purchased together with the display information, and the information which is usable to specify the target person who reads or views the display information (for example, the automobile registration number or the identification information for distinguishing the terminal device possessed by the user or the target person). The acquired information can be registered in the predetermined database (reservation display information DB 19) while being correlated with the reservation ID for distinguishing the purchase reservation.

The management server 10 can display the display information adapted to the preference and/or the purpose of the user on the signage apparatus 30 on the date and time in the time zone designated by the user, on the basis of the information of the signage frame designated by the reservation ID registered in the database after the purchase reservation of the signage frame. The management server 10 allows the signage apparatus 30 to display the display information at the timing of the date and time and the time zone designated by the user, and thus the target person, who reads or views the display information, can be allowed to visually recognize the information when (at the timing at which) the user intends to allow the target person to see the display information. Note that the management server 10 may output the display information, taking the opportunity of the acceptance of the display request with respect to the display information, from the terminal device 20 in which the application is executed, on the date and time in the time zone designated by the user. The management server 10 can output the display information to the signage apparatus 30 at the timing designated by the user who operates the terminal device 20.

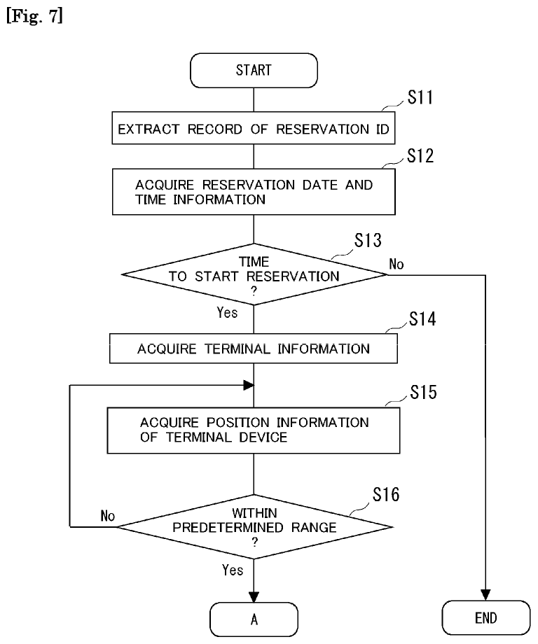

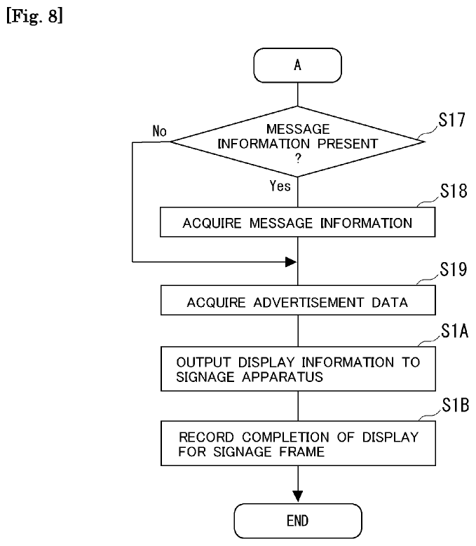

Next, an explanation will be made about the process illustrated in FIGS. 7 and 8. FIGS. 7 and 8 are flow chart illustrating an exemplary display process for displaying the message information and the display information reserved to be purchased. The process illustrated in FIGS. 7 and 8 is periodically executed for every reservation ID in which the status of “uncompleted” is stored in the completion status field of the reservation display information DB 19. In accordance with the process illustrated in FIGS. 7 and 8, the display information and the message information, which are to be displayed in the signage frame reserved to be purchased, are displayed at the timing at which the user or the target person can visually recognize the information. Note that the process illustrated in FIGS. 7 and 8 is an example of the process in which the display information is displayed on the signage apparatus 30 on the basis of the position information of the terminal device 20 possessed by the user or the target person.

In the flow chart illustrated in FIG. 7, the management server 10 makes reference to the reservation display information DB 19 to extract the record of the signage frame registered with the reservation ID (S11). The extracted record is temporarily stored in a predetermined area of the main storage unit 102. The management server 10 acquires the reservation date and time information of the signage frame from the extracted record of the reservation ID (S12). The reservation date and time information is stored in the reservation date and time field.

The management server 10 judges whether or not the present time arrives at the time to start the reservation time zone designated in the reservation date and time information (S13). If the present time arrives at the time to start the reservation time zone (S13, “Yes”), the management server 10 proceeds to the process of S14. On the other hand, if the present time does not arrive at the time to start the reservation time zone (S13, “No”), the management server 10 terminates the process illustrated in FIGS. 7 and 8.

Note that in the process of S13, the management server 10 may previously provide a margin for the time to start the reservation time zone. The margin for the start time can be provided in any unit time, for example, in minutes. For example, if a margin of 5 minutes is provided, the time, which is 5 minutes before the start time, is the start time of the processing target. When the margin is provided as described above, it is thereby possible to display the advertisement content while taking account of the visual recognition environment and the road environment of the place at which the signage apparatus 30 is installed.

In the process of S14, the management server 10 acquires the registration information (terminal information) of the terminal device 20 for specifying the display target person stored in the display target person field. The terminal information includes, for example, the identification information of the terminal device 20 possessed by the user or the target person intended by the user (for example, telephone number, mail address, MAC address and the like). The management server 10 acquires the position information at the present point in time detected by the terminal device on the basis of the identification information of the terminal device 20 (S15).

The management server 10 notifies, for example, the terminal device 20 of the transmission request for the position information (latitude, longitude) by the aid of the communication unit 104. The terminal device 20 acquires the position information of the subject device detected by the position information detecting unit 207 in accordance with the transmission request for the position information sent from the management server 10, and the terminal device 20 transmits the position information to the management server 10. The position information of the terminal device 20 is transmitted to the management server 10 at constant periodic intervals. The position information of the terminal device 20, which is transmitted to the management server 10, is acquired by the aid of the position information acquiring unit 13.

The management server 10 judges whether or not the position of the terminal device 20 at the present point in time is within a predetermined range from the installation position of the signage apparatus 30 which serves as the display target of the signage frame (S16). In this procedure, the predetermined range is previously set on the basis of the installation environment or the signage apparatus. The predetermined range is set, for example, with a unit distance of a radius of 50 m about the center of the installation position of the signage apparatus 30.

If the position of the terminal device 20 is within the predetermined range with respect to the installation position of the signage apparatus 30 (S16, “Yes”), the management server 10 proceeds to the process of S17 illustrated in FIG. 8. On the other hand, if the position of the terminal device 20 is not within the predetermined range with respect to the installation position of the signage apparatus 30 (S16, “No”), the management server 10 proceeds to the process of S15. Note that in the case of the negative judgment to be made in S16 (S16, “No”), the management server 10 may judge that the present time is at or after the time to terminate the reservation time zone, and the management server 10 may terminate the process illustrated in FIGS. 7 and 8.

In the flow chart illustrated in FIG. 8, the management server 10 judges whether or not the message information, which is to be displayed on the signage apparatus 30 together with the display information, is registered (S17). If the information (for example, “---”, blank or the like), which indicates the absence of the message to be displayed, is stored in the message information field (S17, “No”), the management server 10 proceeds to the process of S19. On the other hand, if the character or letter information or the identification number for specifying the character or letter information is stored in the message information field (S17, “Yes”), the management server 10 proceeds to the process of S18.

In the process of S18, the management server 10 acquires the message information to be displayed on the signage apparatus 30 together with the display information. For example, the character or letter information stored in the message information field or the character or letter information specified on the basis of the identification number is acquired as the message information. The acquired message information is delivered to the process of S1A.

In the process of S19, the management server 10 acquires, as the display information, the advertisement data to be displayed in the signage frame. The management server 10 acquires the display data of the advertisement content stored in the advertisement data field. The acquired advertisement data is delivered to the process of S1A.

In the process of S1A, the management server 10 outputs the information (display information) to be displayed in the signage frame to the signage apparatus 30. The message information acquired in the process of S18 and the advertisement data (display data of the advertisement content) acquired in the process of S19 are outputted to the signage apparatus 30. Then, the management server 10 records the completion of the display for the signage frame in relation to the signage apparatus 30 as the processing target (S1B). For example, the management server 10 makes reference to the reservation display information DB 19 to record the status information of “completed” or the like in the completion status field of the signage apparatus. After the process of S1B, the process illustrated in FIGS. 7 and 8 is terminated.

The signage apparatus 30 allows the display unit 304 to display the information to be displayed in the signage frame as outputted from the management server 10. The user of the terminal device 20 or the target person intended by the user, who is positioned within the predetermined range with respect to the installation position of the signage apparatus 30, can read or view the display information displayed on the display unit 304. For example, the user of the terminal device 20 or the target person intended by the user can visually recognize the advertisement content displayed on the display unit 304 and the message information displayed together with the advertisement content at the timing at which the user or the target person passes in front of the signage apparatus 30.

Note that in the process illustrated in FIGS. 7 and 8, the management server 10 may execute the processes of S17 to S1A at the timing of the affirmative judgment in S13 (S13, “Yes”) to output the information to be displayed in the signage frame, to the corresponding signage apparatus 30. Then, the instruction may be made such that the processes of S14 to S16 are executed after the process of S1A to display the information (advertisement data, message information) outputted to the signage apparatus 30 at the timing of the affirmative judgment in S16 (S16, “Yes”). The signage apparatus 30 can display, on the display unit 304, the information to be displayed in the signage frame, at the timing of the instruction notified from the management server 10.

According to the process as described above, the management server 10 can output, to the signage apparatus 30, the information (display information, message information) to be displayed in accordance with the purchased and reserved signage frame, in accordance with the reserved and designated due date and the reserved and designated time zone. According to the signage system 1 concerning the first embodiment, the display information and the message information, which are adapted to the preference and/or the purpose of the user, can be displayed on the signage apparatus 30 in the time zone intended by the user. The user or the target person intended by the user can read or view the display information and the message information displayed on the display unit 304 of the signage apparatus 30 in the time zone desired by the user.

Further, the management server 10 can specify that the target person is positioned within the predetermined range from the signage apparatus 30, on the basis of the position information transmitted from the terminal device 20 of the target person who will read or view the display information and the message information displayed in the signage frame. Then, the management server 10 can allow the signage apparatus 30 to display the display information and the message information displayed in the signage frame, at the timing at which the target person positioned within the predetermined range is specified.

The signage system 1 according to the first embodiment can detect the target person positioned within the predetermined range in which the information displayed on the signage apparatus 30 can be visually recognized, and the signage system 1 can allow the signage apparatus to display the display information and the message information adapted to the preference and/or the purpose of the user. According to the first embodiment, the content intended to be seen (display information and message information) can be displayed on the signage apparatus 30 at the timing at which the person (target person intended by the user), who is intended to see the content, can visually recognize the content.

### First Modification of First Embodiment

A management server 10 according to a first modification has such a form that a target person is detected on the basis of a screen image photographed by a camera 306 provided for a signage apparatus 30. In the first modification, for example, an automobile registration number, which is registered in a display target person field of a reservation display information table, is detected.

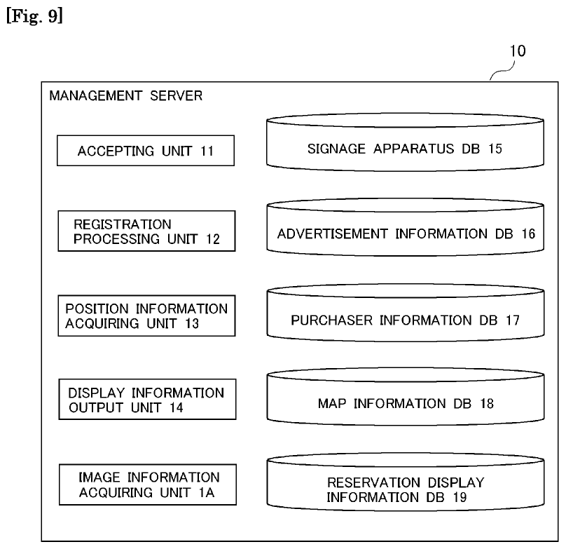

FIG. 9 is a diagram illustrating an exemplary functional configuration of the management server 10 according to the first modification. The management server 10 of the first modification is provided with an image information acquiring unit 1A as functional configuration. Note that the other configuration except for the image information acquiring unit 1A is the same as or equivalent to the functional configuration illustrated in FIG. 4. Further, the hardware configuration of the management server 10, the terminal device 20, and the signage apparatus 30 is the same as or equivalent to the hardware configuration illustrated in FIG. 2. An explanation will be made below principally about a feature in relation to which the first modification is different from the first embodiment.

The image information acquiring unit 1A illustrated in FIG. 9 acquires the screen image (image information) transmitted from the signage apparatus 30 to temporarily store the screen image (image information) in a predetermined area of the main storage unit 102 while allowing the image information to be correlated with the time information and the identification information (apparatus ID) of the signage apparatus 30. The image information acquiring unit 1A delivers the acquired image information and the like to the display information output unit 14. The display information output unit 14 detects the automobile registration number of the vehicle driven by the target person, for example, on the basis of the image information to allow the signage apparatus 30 to display the display information and the message information to be displayed in the signage frame at the timing of the detection.

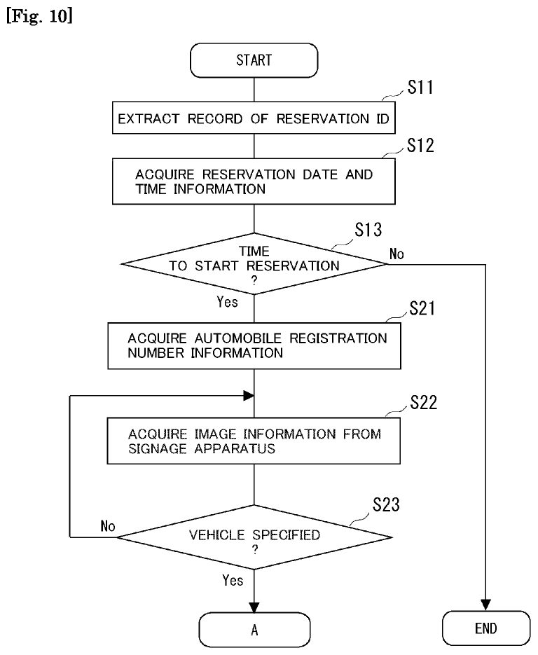

FIG. 10 is a flow chart illustrating an exemplary display process according to the first modification. In FIG. 10, processes of S21 to S23 are executed in place of the processes of S14 to S16 depicted in the flow chart illustrated in FIG. 7. According to the processes of S21 to S23, the process for detecting the automobile registration number is executed on the basis of the image information.

In the flow chart illustrated in FIG. 10, after the affirmative judgment in S13 (S13, “Yes”), the management server 10 acquires the automobile registration number (automobile registration information) of the vehicle registered to specify the display target person stored in the display target person field (S21). The vehicle is the vehicle on which the target person and/or the user get(s). The management server 10 notifies the signage apparatus 30 designated by the apparatus ID of the request to transmit the image information by the aid of the communication unit 104. The signage apparatus 30 starts the photographing operation to photograph the front area disposed in front of the signage apparatus by operating the camera 306, taking the opportunity of the transmission request for the image information. The signage apparatus 30 acquires the screen image (image information) photographed by the aid of the camera 306, and the screen image is transmitted to the management server 10 at constant periodic intervals. The management server 10 acquires the screen image of the front area transmitted from the signage apparatus 30 by the aid of the image information acquiring unit 1A (S22).

In the process of S23, it is judged whether or not the vehicle, which corresponds to the automobile regenerate number, is specified. The management server 10 specifies the vehicle which passes through the front area of the signage apparatus 30, for example, by means of the pattern matching or the like from the frame image photographed in a predetermined frame period to read the automobile registration number marked on the number plate of the vehicle. Then, the management server 10 collates the automobile registration number registered by the registration ID with the automobile registration number read from the image information.

If the vehicle, which corresponds to the automobile registration number, is specified as a result the collation (S23, “Yes”), the management server 10 proceeds to the process of S17 illustrated in FIG. 8. On the other hand, if the vehicle, which corresponds to the automobile registration number, is not specified (S23, “No”), the management server 10 proceeds to the process of S22. The management server 10 performs the collation between the registered automobile registration number and the automobile registration number read from the image information, with respect to the target of the screen image transmitted from the signage apparatus 30 at the next periodic interval, and the vehicle is specified. Note that also in the case of the negative judgment in S23 (S23, “No”), it is also allowable to judge that the present time is at or after the time of termination of the reservation time zone, in the same manner as the process of S16, and the display process of the first modification may be terminated.

According to the process as described above, the management server 10 of the first modification can detect the automobile registration number registered in the display target person field of the reservation display information table on the basis of the screen image photographed by the camera 306 provided for the signage apparatus 30. Then, the management server 10 of the first modification can allow the signage apparatus 30 to display the display information and the message information at the timing at which the detected vehicle passes through the front area of the signage apparatus 30.

### Second Modification of First Embodiment

A management server 10 according to a second modification has such a form that a target person is detected on the basis of the short distance wireless communication between a communication unit 305B provided for a signage apparatus 30 and a communication unit 206B provided for the terminal device 20. In the second modification, for example, the terminal device 20, which is registered in the display target person field of the reservation display information table, is detected by the aid of the short distance wireless communication with the signage apparatus 30. Note that the functional configuration of the management server 10 of the second modification is the same as or equivalent to the functional configuration illustrated in FIG. 4. Further, the hardware configuration of the management server 10, the terminal device 20, and the signage apparatus 30 is the same as or equivalent to the hardware configuration illustrated in FIG. 2. An explanation will be made below principally about a feature in relation to which the second modification is different from the first embodiment.

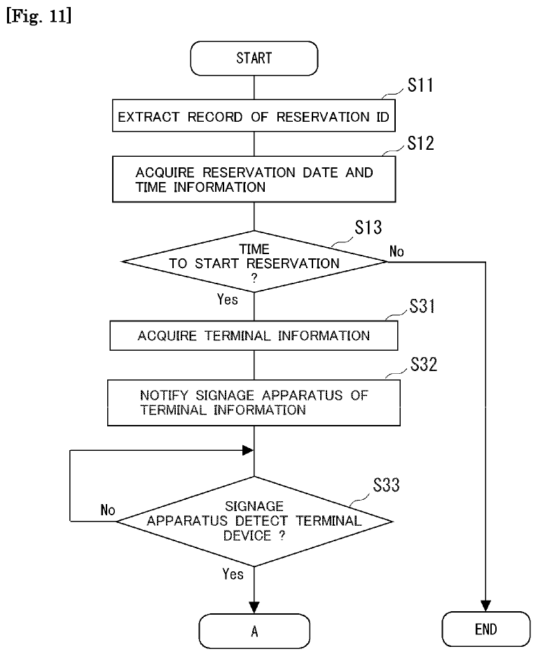

FIG. 11 exemplifies a flow chart illustrating a display process according to the second modification. In FIG. 11, processes of S31 to S33 are executed in place of the processes of S14 to S16 depicted in the flow chart illustrated in FIG. 7. According to the processes of S31 to S33, the process for detecting the terminal device is executed on the basis of the short distance wireless communication between the signage apparatus 30 and the terminal device 20.

In the flow chart illustrated in FIG. 11, after the affirmative judgment in S13 (S13, “Yes”), the system acquires the registration information (terminal information) of the terminal device 20 for specifying the display target person stored in the display target person field (S31). The terminal information includes, for example, the MAC address of the terminal device 20 possessed by the user or the target person intended by the user. The management server 10 notifies the signage apparatus 30 designated by the apparatus ID of the MAC address of the terminal device 20 to serve as the detection target, by the aid of the communication unit 104 (S32).

The signage apparatus 30 transmits a response request directed to the terminal device 20 corresponding to the MAC address at a constant periodic interval by the aid of the communication unit 305B, for example, taking the opportunity of the notification of the MAC address. The response request includes the identification information (for example, apparatus ID and MAC address) for distinguishing the signage apparatus 30. If the terminal device 20 is present within a range in which the short distance wireless communication can be made with the signage apparatus 30, the response directed to the signage apparatus 30 is replied by the aid of the short distance wireless communication. The signage apparatus 30 notifies the management server 10 of the information which indicates the detection of the response, taking the opportunity of the reception of the response from the terminal device 20 with respect to the response request. The information, which indicates the detection of the response, includes the time information at which the response is received and the apparatus ID of the signage apparatus 30.

In the process of S33, the management server 10 judges whether or not the signage apparatus 30 detects the terminal device 20. If the information, which indicates the detection of the response, is notified from the signage apparatus 30 (S33, “Yes”), the management server 10 proceeds to the process of S17 illustrated in FIG. 8. On the other hand, if the information, which indicates the detection of the response, is not notified from the signage apparatus 30 (S33, “No”), the management server 10 repeats the process of S33. Note that also in the case of the negative judgment in S33 (S33, “No”), it is also allowable to judge that the present time is at or after the time of termination of the reservation time zone, in the same manner as the process of S16, and the display process of the second modification may be terminated.

According to the process as described above, the management server 10 of the second modification can detect the terminal device 20 existing in the range in which the short distance wireless communication can be made with respect to the installation position of the signage apparatus 30 on the basis of the short distance wireless communication between the signage apparatus 30 and the terminal device 20. Then, the management server 10 of the second modification can allow the signage apparatus 30 to display the display information and the message information at the timing at which the terminal device 20 is detected.

### Second Embodiment

A second embodiment has such a form that a target person, who fulfills a specified condition such as a personal appearance and a fashion, is detected, and a signage apparatus 30 is allowed to display the display information correlated with the condition at a timing of the detection.

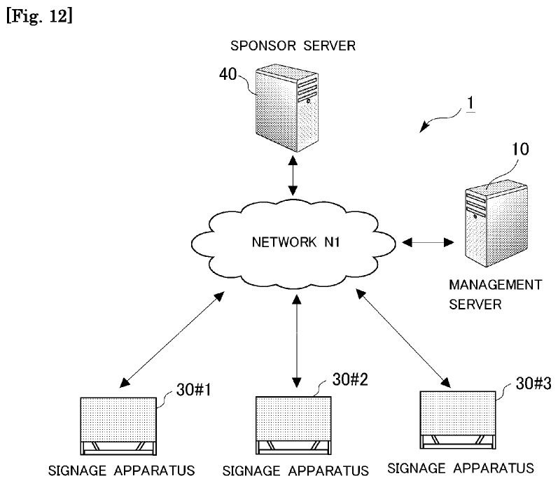

FIG. 12 is a diagram illustrating an exemplary configuration of a signage system 1 according to the second embodiment. The signage system 1 according to the second embodiment is different from the signage system 1 according to the first embodiment illustrated in FIG. 1 in that the signage system 1 according to the second embodiment does not include the terminal device 20. Respective constitutive apparatuses or devices are the same as or equivalent to those of the first embodiment.

Further, the management server 10 and the sponsor server 40 according to the second embodiment have the hardware configuration which is the same as or equivalent to the configuration of the first embodiment illustrated in FIG. 3. Then, it is also allowable that the communication unit 305B illustrated in FIG. 3 is not provided for the signage apparatus 30 according to the second embodiment.

In the second embodiment, for example, it is assumed that the advertiser designates the display information to be displayed in the signage frame by the aid of the sponsor server 40, and the advertiser designates the specified condition such as the personal appearance and the fashion of the target person who is intended to read or view the display information. The management server 10 stores, in the advertisement information DB B1B, the conditional display information accepted by the aid of the sponsor server 40. In the advertisement information DB B1B, the specified condition, which includes the personal appearance and the fashion of the target person who is intended to read or view the display information, is managed together with the display information.

The management server 10 detects the target person who fulfills the specified condition and who is intended to read or view the display information designated by the advertiser, for example, on the basis of the screen image of the front area photographed by the aid of the camera 306 provided for the signage apparatus 30. Then, the management server 10 allows the signage apparatus 30 to display the display information correlated with the condition, at the timing of the detection. Also in the second embodiment, the content (display information) can be designated so that the person (target person who fulfills the condition designated by the advertiser) intended to see the content is allowed to see the content at the timing (date and time, time zone) at which it is intended to allow the person to see the content, by the aid of the signage apparatus 30.

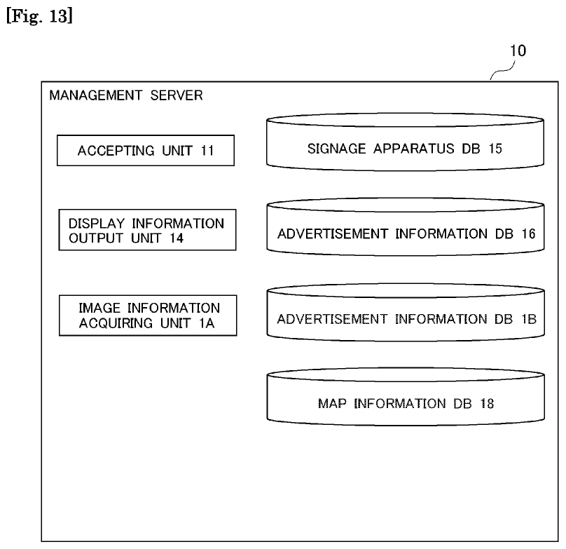

FIG. 13 is a diagram illustrating an exemplary functional configuration of the management server 10 according to the second embodiment. The management server 10 according to the second embodiment includes, as functional constitutive elements or components, an accepting unit 11, a display information output unit 14, an image information acquiring unit 1A, a signage apparatus DB 15, an advertisement information DB 16, an advertisement information DB 1B, and a map information DB 18. The accepting unit 11, the display information output unit 14, the signage apparatus DB 15, and the map information DB 18 are the same as or equivalent to those of the first embodiment, any explanation of which will be omitted. However, the accepting unit 11 stores, in the advertisement information DB 1B, the display information for which the advertiser designates the condition of, for example, the personal appearance and the fashion of the target person intended to read or view the display information. Further, the image information acquiring unit 1A is the same as or equivalent to the image information acquiring unit 1A of the first modification of the first embodiment, any explanation of which will be omitted.

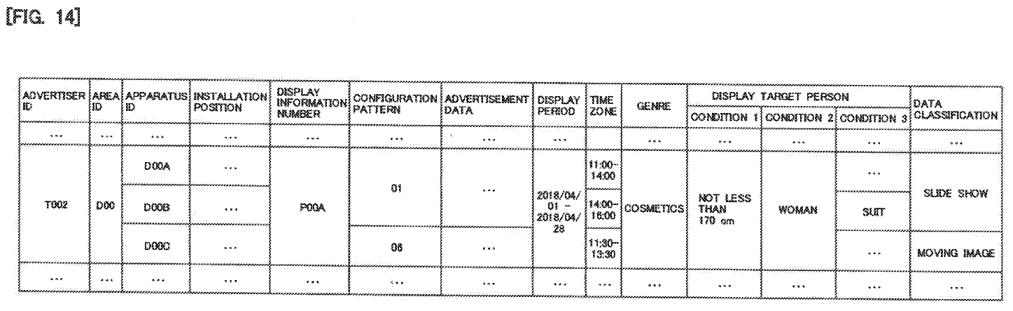

FIG. 14 is a diagram illustrating an exemplary advertisement information stored in the advertisement information DB 1B. As illustrated in FIG. 14 by way of example, the display information, in which the specified condition is designated for the target person intended to read or view the display information, is managed as an advertisement information table. The field can be appropriately added, changed, and deleted in relation to the information registered in the advertisement information table.

The advertisement information table exemplified in FIG. 14 has respective fields of “advertiser ID”, “area ID”, “apparatus ID”, “installation position”, “display information number”, “configuration pattern”, “advertisement data”, “display period”, “time zone”, “genre”, “display target person”, and “data classification”. The advertiser ID for distinguishing the advertiser is stored in the advertiser ID field. An entrepreneur code of the advertiser is exemplified as the advertiser ID. The area ID, the apparatus ID, the installation position, the display information number, the configuration pattern, the advertisement data, the genre, and the data classification are the same as or equivalent to those shown in the reservation display information table illustrated in FIG. 5, any explanation of which will be omitted.

The designation of the period for displaying the display information is stored in the display period field. In FIG. 14, a period from “2018/04/01” to “2018/04/28” is exemplified. The designation of the time zone for displaying the display information is stored in the time zone field. In FIG. 14, in the case of the apparatus ID “D00A”, a time zone of “11:00-14:00” is designated. The condition, which is provided to specify the target person who is allowed to read or view the display information, as accepted by the aid of the sponsor server 40, is stored in the display target person field. The display target person field has the subfields corresponding to the number of designated conditions. The subfields of “condition 1” to “condition 3” are exemplified in FIG. 14.

Note that in “condition 1”, the feature of the personal appearance of a height of “not less than 170 cm” is designated for the apparatus ID's “D00A”, “D00B”, and “D00C”. Further, “woman” is designated as the condition of the display target person in “condition” in the same manner as described above. In “condition 3”, a fashion of “suit” is designated for the apparatus ID “D00B”.

For example, as for the apparatus ID “D00A”, the display information is displayed in the designated time zone “11:00-14:00” on condition that any “woman”, who has the height of “not less than 170 cm”, is detected as the target person. The display information, which is to be displayed on the apparatus ID “D00A”, is the advertisement content having the data classification of “slide show” as designated by the display number “P00A” and the configuration pattern “01”. Similarly, as for the apparatus ID “D00B”, the display information is displayed in the designated time zone “14:00-16:00” on condition that any “woman”, who has the height of “not less than 170 cm” and who wears “suit”, is detected as the target person. The display information, which is to be displayed on the apparatus ID “D00B”, is the advertisement content having the data classification of “slide show” as designated by the display number “P00A” and the configuration pattern “01”. Further, as for the apparatus ID “D00C”, the display information is displayed in the designated time zone “11:30-13:30” on condition that any “woman”, who has the height of “not less than 170 cm”, is detected as the target person. The display information, which is to be displayed on the apparatus ID “D00C”, is the advertisement content having the data classification of “moving image” as designated by the display number “P00A” and the configuration pattern “06”.

(Process Flow)

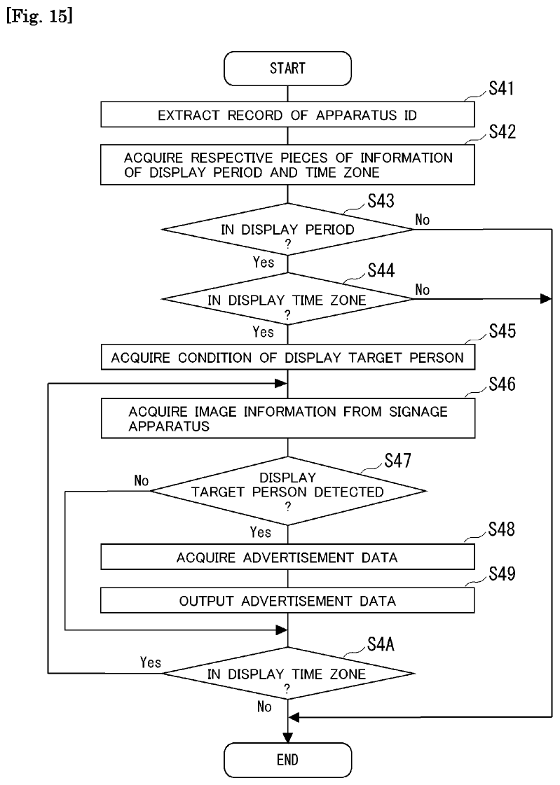

Next, an explanation will be made with reference to FIG. 15 about the process of the management server 10 according to the second embodiment. FIG. 15 is a flow chart illustrating an exemplary display process for displaying the display information according to the second embodiment. The process illustrated in FIG. 15 is periodically executed for each of the apparatus ID's registered in the advertisement information DB 1B.

In the flow chart illustrated in FIG. 15, the management server 10 makes reference to the advertisement information DB 1B to extract the record corresponding to the apparatus ID of the signage apparatus 30 as the processing target (S41). The extracted record is temporarily stored in a predetermined area of the main storage unit 102. The management server 10 acquires the respective pieces of information of the display period and the time zone of the signage frame from the extracted record of the apparatus ID (S42).

The management server 10 judges whether or not the present data is in the display period (S43). If the present data is in the display period (S43, “Yes”), the management server 10 proceeds to the process of S44. On the other hand, if the present data is not in the display period (S43, “No”), the management server 10 terminates the process illustrated in FIG. 15.

In the process of S44, the management server 10 judges whether or not the present time is in the display time zone. If the present time is in the display time zone (S44, “Yes”), the management server 10 proceeds to the process of S45. On the other hand, if the present time is not in the display time zone (S44, “No”), the management server 10 terminates the process illustrated in FIG. 15.

The management server 10 acquires the condition of the display target person from the extracted record of the apparatus ID (S45). For example, in the advertisement information table illustrated in FIG. 14, as for the apparatus ID “D00A”, “not less than 170 cm” stored in the condition 1 subfield and “woman” stored in the condition 2 subfield are acquired. The management server 10 temporarily stores the acquired condition(s) in a predetermined area of the main storage unit 102 while being correlated with the apparatus ID, and the routine proceeds to the process of S46.

In the process of S46, the management server 10 acquires the image information transmitted at a constant periodic interval from the signage apparatus 30 corresponding to the apparatus ID. For example, a screen image of the front area, which is photographed by the aid of the camera 306 provided for the signage apparatus 30, is acquired as the image information. The image information, which is acquired from the signage apparatus 30 corresponding to the apparatus ID, is temporarily stored in a predetermined area of the main storage unit 102 together with the time information.

In the process of S47, it is judged whether or not the display target person, who falls under the designated condition, is specified. The management server 10 specifies the target person who falls under the designated condition, for example, by means of the pattern matching with respect to the frame image photographed at the predetermined frame period. For example, as for the apparatus ID “D00A”, the display target person, who passes through the front area of the signage apparatus and who falls under the condition 1 of “not less than 170 cm” and the condition 2 of “woman”, is specified on the basis of the image information.

If the display target person, who falls under the designated condition, is specified (S47, “Yes”), the management server 10 proceeds to the process of S48. On the other hand, if the display target person, who falls under the designated condition, is not specified (S47, “No”), the management server 10 proceeds to the process of S4A.

In the process of S48, the management server 10 acquires the advertisement data from the extracted record of the apparatus ID. Then, the management server 10 outputs the acquired advertisement data as the display information to be displayed in the signage frame, to the signage apparatus 30 (S49). The signage apparatus 30, which corresponds to the apparatus ID, allows the display unit 304 to display the display information (display data of the advertisement content) outputted from the management server 10.

In the process of S4A, it is judged again whether or not the present time is in the display time zone. If the present time is in the display time zone (S4A, “Yes”), the management server 10 proceeds to the process of S46. In the display time zone, the processes from S46 to S4A are repeated at constant periodic intervals. On the other hand, if the present time is not in the display time zone (S4A, “No”), the management server 10 terminates the process illustrated in FIG. 15.

According to the process as described above, the management server 10 of the second embodiment can detect the target person who falls under the specified condition including, for example, the personal appearance and the fashion, on the basis of the screen image (image information) photographed by the camera 306 provided for the signage apparatus 30. The management server 10 can specify, for example, the target person who passes through the front area of the signage apparatus 30. Then, the management server 10 can allow the signage apparatus 30 to display the display information (display data of the advertisement content) correlated with the specified condition, at the timing of the detection of the target person.

### Modification of Second Embodiment

The second embodiment has been explained assuming that the advertiser designates the specified condition such as the personal appearance and the fashion of the target person who is intended by the advertiser to read or view the display information. Any user other than the advertiser can designate the condition as described above. For example, the condition may be designated, for example, by an advertisement adviser or a regional vitalization adviser of a region in which the signage apparatus 30 is installed.

In the form of the first modification, for example, the signage frame, which is requested from the advertiser, is purchased by the user other than the advertiser (for example, a regional vitalization adviser, an advertisement adviser or the like), as explained in the first embodiment. The user, who purchases the signage frame, registers the purchase reservation of the signage frame by the aid of the terminal device 20 possessed by the user himself/herself. Then, the user of the first modification designates the specified condition such as the personal appearance and the fashion of the target person intended to read or view the display information, with respect to the purchased signage frame. The form of the first modification is different from that of the first embodiment in that the condition is designated as described above, and the form of the first modification is different from that of the second embodiment in that the user, who purchased the signage frame, designates the condition.

For example, the regional vitalization adviser, who purchased the signage frame, selects the display information and designates the condition of the target person intended to read or view the selected display information, in order to vitalize inhabitants who live in the area or region in which the signage apparatus 30 is installed. For example, the display information is selected depending on, for example, the age configuration, the sexuality configuration, and the occupation configuration of the regional inhabitants (local residents). For example, the regional inhabitants can take chances to make mutual communication by using the display information displayed on the signage apparatus 30, and it is possible to contemplate the vitalization.

Further, the advertisement adviser, who purchased the signage frame, selects the display information and designates the condition of the target person intended to read or view the selected display information, in order to effect a direct adviser contract with the advertiser. For example, the advertisement adviser selects the installation position of the signage apparatus 30 in accordance with the arrangement performed by himself/herself, and the advertisement adviser selects the display classification and/or the configuration pattern of the advertisement content. Then, the advertisement adviser can promote himself/herself to the advertiser by using, as the achievement of the adviser by himself/herself, the improvement in the sales of, for example, the advertised target merchandise.

### Third Embodiment

A third embodiment has such a form that the visual recognition information is acquired by the aid of the terminal device 20 of the user allowed to read or view the display information in the first embodiment to accumulate the history of the visual recognition information, and any message information is displayed together with any exclusive display information when the number of times of visual recognition performed by the user arrives at a certain number of times. In this case, the visual recognition information is the information which indicates that the display information, which is displayed on the signage apparatus 30, is read or viewed (visually recognized). The visual recognition information is acquired by the aid of the short distance wireless communication between the communication unit 206B of the terminal device 20 and the communication unit 305B of the signage apparatus 30. The terminal device 20 notifies the signage apparatus 30 of the visual recognition information by means of the execution of an application.

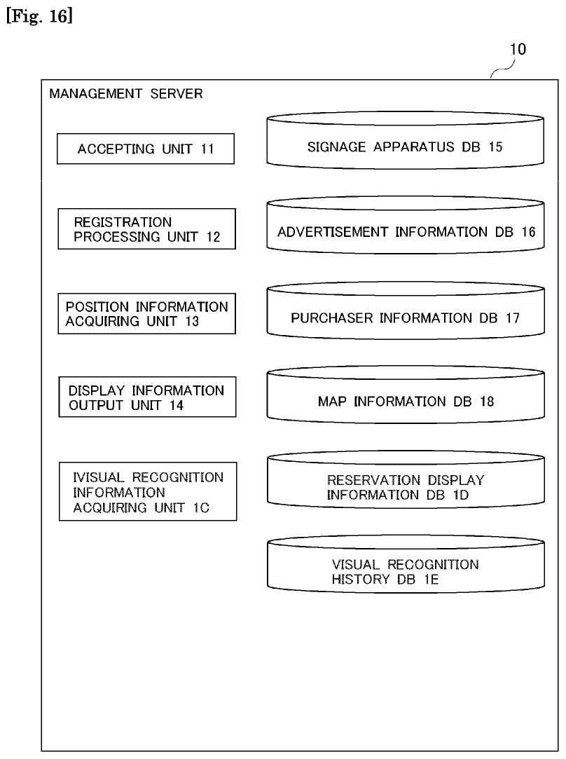

FIG. 16 is a diagram illustrating an exemplary functional configuration of a management server 10 according to the third embodiment. Those illustrated in FIG. 16 are different from those of the first embodiment in that a visual recognition information acquiring unit 1C, a reservation display information DB 1D, and a visual recognition history DB 1E are provided. Different features will be principally explained below.

The visual recognition information acquiring unit 1C acquires the visual recognition information transmitted from the signage apparatus 30. The visual recognition information is correlated with the apparatus ID of the signage apparatus 30, the identification information (MAC address or the like) of the terminal device 20, and the time information at which the signage apparatus 30 accepted the visual recognition information. The visual recognition information acquiring unit 1C accumulates the acquired visual recognition information in the visual recognition history DB 1E. The visual recognition history DB 1E includes, for example, a visual recognition information history table for each of the apparatus ID's. The visual recognition information acquiring unit 1C records the identification information (MAC address or the like) of the terminal device 20 and the time information at which the visual recognition information was accepted, in the visual recognition information history table of the corresponding apparatus ID.

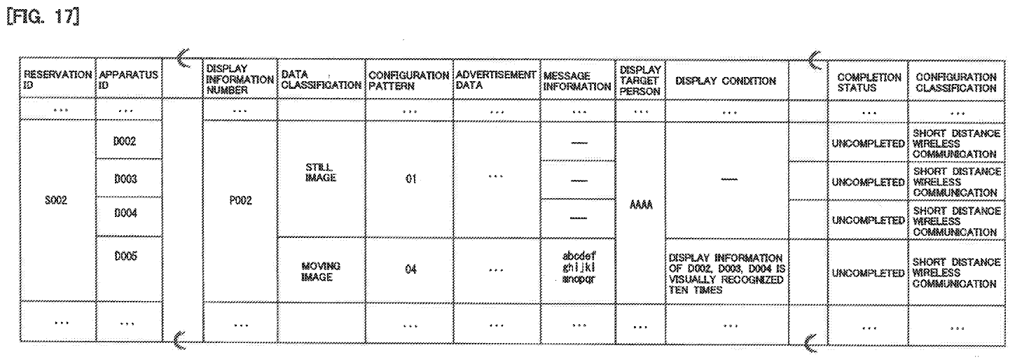

FIG. 17 is a diagram illustrating an exemplary reservation display information stored in the reservation display information DB 1D. The reservation display information table exemplified in FIG. 17 is different from that of the first embodiment in that a display condition field is provided. A condition of the number of times of visual recognition, which is provided to display exclusive display information when the number of times of visual recognition arrives at a certain number of times, is stored in the display condition field. Note that if the display condition is absent, the information (for example, “---”, blank or the like), which indicates the absence of the display condition, is stored. In FIG. 17, the display condition is stored for the advertisement content of the data classification “moving image” specified by the configuration pattern “04” having the display information number “P002” of the apparatus ID “D005”. In FIG. 17, such a condition is stored that the display information, which is displayed on the apparatus ID's “D002”, “D003”, “D004”, is visually recognized “ten times” in sum total.

If the number of times of visual recognition of the advertisement content of the data classification “still image” specified by the configuration pattern “01” of the display information number “P002” arrives at ten, the management server 10 allows the apparatus ID “D005” to display the exclusive display information accompanied with the message information. In this case, the exclusive display information is the advertisement content of the data classification “moving image” specified by the configuration pattern “04” having the display information number “P002” of the apparatus ID “D005”. For example, a scene, in which game characters displayed in “still image” challenge a boss character as an enemy to battle, is displayed as a moving image content on the apparatus ID “D005”.

For example, a child, who rides together on a vehicle, operates the terminal device 20 delivered from his/her mother so that the visual recognition information is notified with respect to the advertisement content of “still image” displayed on the corresponding signage apparatus 30. The terminal device 20 is the device which is designated by the display target person “AAAA”. The signage apparatus 30 accepts the visual recognition information notified from the terminal device 20, and the visual recognition information is transmitted to the management server 10 together with the time information, the identification information of the terminal device, and the apparatus ID of the subject apparatus. The management server 10 acquires the visual recognition information for the signage apparatus by the aid of the visual recognition information acquiring unit 1C, and the visual recognition information is stored in the visual recognition history DB 1E. The management server 10 counts the number of times of visual recognition of the advertisement content on the basis of the visual recognition history for each of the signage apparatuses stored in the visual recognition history DB 1E. Then, the management server 10 outputs the exclusive content and the message to the corresponding signage apparatus 30 (apparatus ID “005”) at the timing at which the counted number of times of visual recognition falls under the display condition stored in the reservation display information table.

(Process Flow)

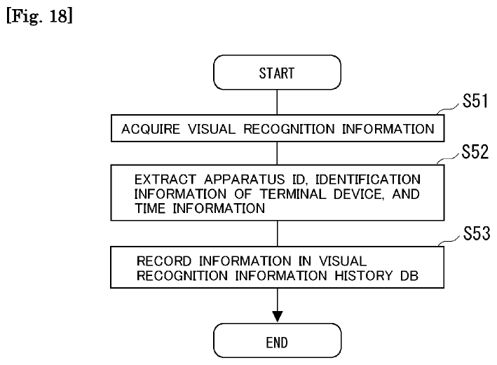

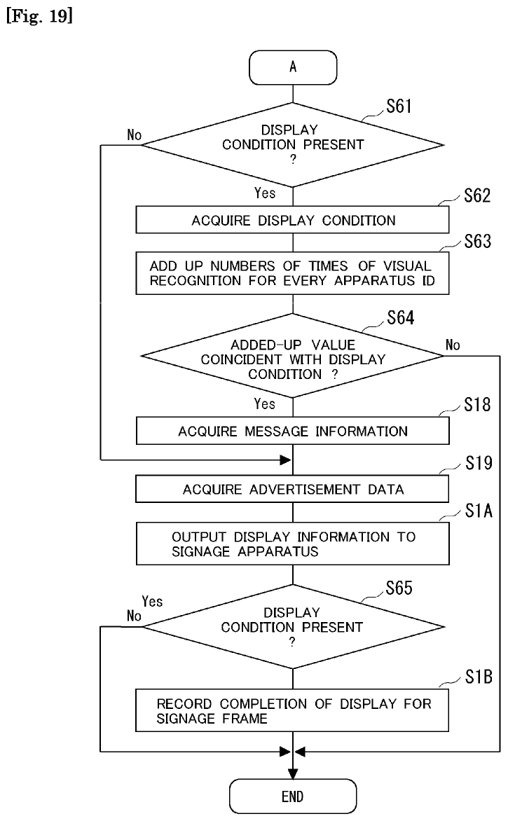

Next, an explanation will be made about the process of the management server 10 according to the third embodiment with reference to FIGS. 18 and 19. FIG. 18 is a flow chart illustrating an exemplary acquiring process for acquiring the visual recognition information. In the flow chart illustrated in FIG. 18, the start of the process is exemplified by a timing at which the visual recognition information transmitted from the signage apparatus 30 is accepted. The management server 10 acquires the accepted visual recognition information (S51). The acquired visual recognition information is temporarily stored in a predetermined area of the main storage unit 102.

The management server 10 extracts the apparatus ID of the signage apparatus 30, the identification information of the terminal device 20, and the time information at which the visual recognition information was received, from the visual recognition information (S52). Then, the management server 10 records the identification information of the terminal device 20 and the time information at which the visual recognition information was received, while being correlated with each other, in the visual recognition information history table corresponding to the apparatus ID of the visual recognition history DB 1E (S53). After the process of S53, the process illustrated in FIG. 18 is terminated.

According to the process as described above, the management server 10 can record the identification information of the terminal device 20 and the time information at which the visual recognition information was accepted by the signage apparatus 30, while being correlated with each other, in the visual recognition history DB 1E, for each of the signage apparatuses which accepted the visual recognition information. The management server 10 can accumulate the acquired visual recognition information as the history in the visual recognition history DB 1E.

Next, the process illustrated in FIG. 19 will be explained. The process illustrated in FIG. 19 is a flow chart illustrating an exemplary process to be executed after the affirmative judgment in S16 (S16, “Yes”) illustrated in FIG. 7 of the first embodiment. In the third embodiment, the processes from S61 to S64 and the processes from S65 to S66 illustrated in FIG. 19 are executed after the affirmative judgment in S16 illustrated in FIG. 7 (S16, “Yes”). Note that the processes of FIG. 7 and FIG. 19 are periodically executed for each reservation ID in which the status of “uncompleted” is stored in the completion status field of the reservation display information DB 1D.

In the flow chart illustrated in FIG. 19, the management server 10 judges whether or not the display condition is registered (S61). If the condition for displaying the exclusive display information is stored in the display condition field (S61, “Yes”), the management server 10 proceeds to the process of S62. On the other hand, if the information (for example, “---”, blank or the like), which indicates the absence of the condition for displaying the exclusive display information, is stored in the display condition field (S61, “No”), the management server 10 proceeds to the process of S19.

In the process of S62, the management server 10 acquires the display condition (apparatus ID for acquiring the visual recognition information, number of times of visual recognition) for allowing the signage apparatus 30 to display the exclusive display information. The apparatus ID, which is designated in the display condition, is delivered to the process of S63. Further, the number of times of visual recognition, which is designated in the display condition, is delivered to the process of S64.

In the process of S63, the management server 10 adds up the numbers of times of visual recognition of the signage apparatus 30 corresponding to the apparatus ID on the basis of the apparatus ID designated by the display condition. For example, the management server 10 makes reference to the visual recognition history DB 1E to specify the history of the accumulated visual recognition information. Then, the management server 10 adds up the numbers of times of visual recognition information accumulated in the history of the terminal device, on the basis of the identification information for distinguishing the terminal device 20 stored in the display target person field. The management server 10 stores the added-up number of times of visual recognition information in a predetermined area of the main storage unit 102, and the routine proceeds to the process of S64.

In the process of S64, it is judged whether or not the added-up number of times of visual recognition information is coincident with the number of times of visual recognition designated by the display condition. If the added-up number of times of visual recognition information is coincident with the number of times of visual recognition designated by the display condition (S64, “Yes”), the management server 10 proceeds to the process of S18. On the other hand, if the added-up number of times of visual recognition information is not coincident with the number of times of visual recognition designated by the display condition (S64, “No”), the management server 10 terminates the process illustrated in FIG. 7 and FIG. 19.

In the processes from S18 to S1A, the process, which is the same as or equivalent to the process illustrated in FIG. 8, is performed. In the process of S1A, the display data of the advertisement content specified by the display information number and the number of the configuration pattern is outputted to the signage apparatus 30 in relation to the apparatus ID designated to acquire the visual recognition information in the display condition. On the other hand, the display data of the advertisement content specified by the display information number and the number of the configuration pattern and the message information to be displayed together with the display data are outputted to the signage apparatus 30 in relation to the apparatus ID for which the display condition is registered.

After the process of S1A, the management server 10 judges whether or not the display condition is registered for the apparatus ID as the processing target (S65). The management server 10 judges whether or not the display condition is registered, in the same manner as the process of S61. If the display condition is registered (S65, “Yes”), the management server 10 proceeds to the process of SM. On the other hand, if the display condition is not registered (S65, “No”), the management server 10 terminates the process illustrated in FIG. 7 and FIG. 19.

In the process of S1B, the completion of the display of the signage frame is recorded for the apparatus ID designated in the display condition and the apparatus ID registered with the display condition. For example, the management server 10 makes reference to the reservation display information DB 19 to collectively record the status information of “completion” or the like in the completion status field corresponding to the apparatus ID. After the process of S1B, the process illustrated in FIG. 7 and FIG. 19 is terminated.

According to the process as described above, the management server 10 according to the third embodiment can judge that the number of times of visual recognition of the user arrives at a certain number of times, on the basis of the history of the visual recognition information of the display information displayed in the signage frame of the designated signage apparatus 30. If the number of times of visual recognition of the user arrives at the certain number of times, the management server 10 can display the exclusive display information and the message information in the signage frame of the designated signage apparatus 30.

Note that in the third embodiment, the form, in which the target person is detected on the basis of the screen image photographed by the camera 306 provided for the signage apparatus 30 as described in the first modification of the first embodiment, can be also applied. Similarly, it is possible to adapt the form in which the target person is detected on the basis of the short distance wireless communication between the signage apparatus 30 and the terminal device 20 as described in the second modification of the first embodiment.

### Other Embodiments

The embodiments described above are exemplified by way of example in every sense. Those disclosed in the embodiments of the present disclosure may be carried out while appropriately making changes within a range without deviating from the gist or essential characteristics thereof. The processes and the means explained in this disclosure can be carried out while freely combining them unless any technical contradiction or inconsistency arises.

Further, the process, which has been explained as being performed by one apparatus or device, may be executed by a plurality of apparatuses or devices in a shared manner. Alternatively, the process, which has been explained as being performed by the different apparatuses or devices, may be executed by one apparatus or device without causing any problem. In the computer system, it is possible to flexibly change the way of realization of the respective functions by means of any hardware configuration (server configuration).

A program, which allows an information processing apparatus or any other machine, apparatus, or device (hereinafter referred to as “computer or the like”) to realize any one of the functions described above, can be recorded on a storage medium which is readable by the computer or the like. Then, it is possible to provide the function by reading and executing the program on the storage medium by the computer or the like.

The storage medium, which is readable by the computer or the like, herein refers to such a storage medium that the information such as the data, the program or the like is accumulated in accordance with the electric, magnetic, optical, mechanical, or chemical action, and the information can be read from the computer or the like. The storage medium, which is included in the storage medium as described above and which can be removed from the computer or the like, is exemplified, for example, by flexible disk, magneto-optical disk, CD-ROM, CD-R/W, DVD, Blu-ray Disc, DAT, 8 mm tape, and memory card such as flash memory or the like. Further, the storage medium, which is fixed to the computer or the like, is exemplified, for example, by hard disk and ROM.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information system comprising a controller which includes at least one processor, the controller configured to execute:
acquisition of specification information for specifying display information to be displayed on a signage apparatus, of a user as inputted by the aid of an input unit; and
output of the display information to the signage apparatus at a predetermined timing.

2. The information system according to claim 1, wherein the predetermined timing is a timing at which the user himself/herself or a target person intended by the user can visually recognize the display information displayed on the signage apparatus.

3. The information system according to claim 1, wherein the display information includes advertisement information which is free of charge and which is provided at an expense borne by a defrayer.

4. The information system according to claim 2, wherein the controller further configured to execute:
detection of the user himself/herself or the target person intended by the user; and
output of the display information to the signage apparatus by taking an opportunity of the detection of the user himself/herself or the target person intended by the user.

5. The information system according to claim 3, wherein the controller further configured to execute:
detection of the user himself/herself or the target person intended by the user; and
output of the display information to the signage apparatus by taking an opportunity of the detection of the user himself/herself or the target person intended by the user.

6. The information system according to claim 2, wherein the controller further configured to execute:
detection of the user himself/herself or the target person intended by the user;
acquisition of a timing designated by the user; and
output of the display information to the signage apparatus at the timing designated by the user.

7. The information system according to claim 3, wherein the controller further configured to execute:
detection of the user himself/herself or the target person intended by the user;
acquisition of a timing designated by the user; and
output of the display information to the signage apparatus at the timing designated by the user.

8. The information system according to claim 4, wherein the controller further configured to execute:
acquisition of visual recognition information with respect to the display information displayed on the signage apparatus, from the user himself/herself or the target person intended by the user;
accumulation of histories of the visual recognition information with respect to the display information displayed on the signage apparatus; and
output of message information set previously together with the display information, if the accumulated visual recognition information with respect to the display information arrives at a certain number of times.

9. The information system according to claim 5, wherein the controller further configured to execute:
acquisition of visual recognition information with respect to the display information displayed on the signage apparatus, from the user himself/herself or the target person intended by the user;
accumulation of histories of the visual recognition information with respect to the display information displayed on the signage apparatus; and
output of message information set previously together with the display information, if the accumulated visual recognition information with respect to the display information arrives at a certain number of times.

10. The information system according to claim 6, wherein the controller further configured to execute:
acquisition of visual recognition information with respect to the display information displayed on the signage apparatus, from the user himself/herself or the target person intended by the user;
accumulation of histories of the visual recognition information with respect to the display information displayed on the signage apparatus; and
output of message information set previously together with the display information, if the accumulated visual recognition information with respect to the display information arrives at a certain number of times.

11. The information system according to claim 7, wherein the controller further configured to execute:
acquisition of visual recognition information with respect to the display information displayed on the signage apparatus, from the user himself/herself or the target person intended by the user;
accumulation of histories of the visual recognition information with respect to the display information displayed on the signage apparatus; and
output of message information set previously together with the display information, if the accumulated visual recognition information with respect to the display information arrives at a certain number of times.

12. An information processing method causing a computer to execute:
a step of acquiring specification information for specifying display information to be displayed on a signage apparatus, of a user as inputted by the aid of an input unit; and
a step of outputting the display information to the signage apparatus at a predetermined timing.

13. A non-transitory storage medium stored with an information processing program, the information processing program causing a computer to execute:
a step of acquiring specification information for specifying display information to be displayed on a signage apparatus, of a user as inputted by the aid of an input unit; and
a step of outputting the display information to the signage apparatus at a predetermined timing.
